(19) United States
(12) Patent Application Publication
(10) Pub. No.: US 2026/0350733 A1
(43) Pub. Date: Nov. 5, 2026

(54) LEARNING CONTENT GENERATION AND ASSESSMENT UTILIZING STRUCTURED SKILL DATA

(71) Applicant: Microsoft Technology Licensing, LLC, Redmond, WA (US)

(72) Inventors: Ryan Michael CURRIE, Spokane, WA (US); Saravanan PALANIYANDI, Redmond, WA (US); Daniel Edward STAFFORD, Seattle, WA (US); Hui XIE, Shanghai (CN); Derek Ronald PETERSON, Cle Elum, WA (US); Helen Pashenkov MILLER, Virginia Beach, VA (US); James G. PARKER, Mullica Hill, NJ (US)

(21) Appl. No.: 19/195,161

(22) Filed: Apr. 30, 2025

(51) Int. Cl. G06Q 50/20

(52) U.S. Cl. CPC G06Q 50/2057

(57) ABSTRACT

Systems, methods, devices, and computer readable storage media described herein provide techniques for generating learning plans utilizing skill data structures and utilizing the generated learning plan to teach skills and/or assess skill proficiency. In an aspect, goal information corresponding to a goal of an account is received. The account is determined to fail to satisfy a skill for fulfilling the goal. A generative artificial intelligence (AI) model is used to generate a learning plan associated with the skill based on the goal and the skill. The learning plan is received from the generative AI model. The learning plan comprises a module for assessing if the account satisfies a validation criterion corresponding to the skill. Execution of the module is caused and an assessment of completion of the module is made. In another aspect, another model is trained utilizing a learning plan.

### BACKGROUND

People may desire to learn new skills or techniques for a variety of reasons. For instance, a person might desire to apply to a new job that requires skills they do not possess or use a tool they are unfamiliar with. In order to learn these new skills, a person can turn to online resources. However, the amount of information on the Internet can be cumbersome due to the vast numbers of documents, videos, tutorials, and other content present there related to different topics. Sorting through such large amounts of content can be difficult, as the filtering out of irrelevant or incorrect information can be laborious.

Entities can make decisions with respect to a person such as a user, employee, or candidate based on the skills that person possesses. In some cases, an entity requires a person to demonstrate in a live interview setting or a trial that they possess a skill.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described herein are embodiments directed to the generation of learning plans utilizing skill data structures and to utilization of generated learning plans to teach a skill and/or assess proficiency with a skill. In an aspect, goal information corresponding to a target goal associated with a user account is received. A determination that the user account fails to satisfy a skill criterion of the target goal is made based on the goal information. The skill criterion specifies a skill for satisfying the target goal. A prompt is provided to a generative artificial intelligence (AI) model, causing the generative AI model to generate a learning plan associated with the skill, the first prompt specifying the target goal and the skill. The learning plan is received from the generative AI model. The learning plan comprises an executable module for assessing whether the user account or a user associated with the user account satisfies a validation criterion corresponding to the skill. The executable module is caused to be executed.

In another aspect of the present disclosure, a response to a module is validated. Goal information corresponding to a target goal of associated with a user account is received and a determination that the user account fails to satisfy a skill criterion of the target goal is made based on the goal information. The skill criterion specifies a skill for satisfying the target goal. A prompt is provided to a generative AI model, causing the model to generate a learning plan associated with the skill, the prompt specifying the target goal and the skill. The learning plan is received from the generative AI model. The learning plan includes a module for assessing if the user account or a user associated with the user account satisfies validation criterion corresponding to the skill. The module is caused to be presented in a user interface. A response to the module indicative of interaction with the first module in the user interface is received and validated. Responsive to validation of the response, the skill is assigned to the user account.

In another aspect, automated learning plan generation is implemented with event detection. A development event is detected with respect to a computer development program associated with a user account. A potential solution to remedy the development event is determined based on the development event. A skill criterion of the potential solution is identified. The skill criterion corresponds to a skill for performing the potential solution. The user account is determined to fail to satisfy the skill criterion. A prompt is provided to a generative AI model, causing the generative AI model to generate a learning plan associated with the skill. The prompt specifies the skill and the potential solution. The learning plan is received from the generative AI model. The learning plan includes an executable module for assessing if the user account or a user associated with the user account satisfies validation criterion corresponding to the skill. The computer development program is caused to execute the first executable module.

In another aspect, automatic skill assessment and assignment is performed. For example, a development event is detected with respect to a computer development program associated with a user account. The user account or a user associated with the user account is determined to satisfy a skill criterion of a skill based at least on the development event. The skill is assigned to the user account.

In another aspect, skill-based event mitigation is performed. For example, a development event is detected with respect to the computer development program. A plurality of potential solutions for remedying the development event are determined. Skill information specifying skills the user account is associated with (e.g., skills possessed by a user of the user account) are received. A potential solution is selected from among the plurality of potential solutions based on the skill information. The selected potential solution is presented in a user interface of the computer development program.

In still another aspect, a model is trained utilizing a learning plan. For example, a set of training goals is received. The training goals specify a model training target and a model architecture plan. A level of relevancy of a skill to the model training target is determined based at least on the model architecture plan. Responsive to determining the level of relevancy satisfies a relevancy criterion, a first generative AI model is utilized to determine a training plan comprising instructions to train a second generative AI model on the skill. The training plan is utilized to train the second generative AI model on the skill.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for learning plan generation and execution, in accordance with an example embodiment.

FIG. 2 shows a block diagram of a system for learning plan generation and execution, in accordance with another example embodiment.

FIG. 3 shows a flowchart of a process for learning plan generation and execution, in accordance with an example embodiment.

FIG. 4 shows a flowchart of a process for assessing module execution performance, in accordance with an example embodiment.

FIG. 5 shows a flowchart of a process for assessing skill criterion, in accordance with another example embodiment.

FIG. 6 shows a block diagram for skill-based resource access, in accordance with an example embodiment.

FIG. 7 shows a flowchart of a process for skill-based authorization of resource access, in accordance with an example embodiment.

FIG. 8 shows a flowchart for learning plan generation and assessment, in accordance with an example embodiment.

FIG. 9 shows a block diagram of a skill object model, in accordance with an example embodiment.

FIG. 10 shows a block diagram of a skill object model, in accordance with another example embodiment.

FIG. 11 shows a block diagram of a skill object model, in accordance with an example embodiment.

FIG. 12 shows a block diagram of a system for automatic skill assessment and learning plan generation, in accordance with an example embodiment.

FIG. 13 shows a flowchart of a process for automatic skill assessment and learning plan generation, in accordance with an example embodiment.

FIG. 14 shows a block diagram of a system for automatic skill assessment and assignment, in accordance with an example embodiment.

FIG. 15 shows a flowchart of a process for automatic skill assessment and assignment, in accordance with an example embodiment.

FIG. 16 shows a block diagram of a system for automatic skill-based event mitigation, in accordance with an example embodiment.

FIG. 17 shows a flowchart of a process for automatic skill-based event mitigation, in accordance with an example embodiment.

FIG. 18 shows a block diagram of a system for skill-based model training, in accordance with an example embodiment.

FIG. 19 shows a flowchart of a process for skill-based model training, in accordance with an example embodiment.

FIG. 20 shows a flowchart of a process for skill-based model validation, in accordance with an example embodiment.

FIG. 21 shows a block diagram of an example computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Learning Plan Generation Utilizing Skill Data Structures

People may desire to learn new skills or techniques for a variety of reasons. For instance, a person may desire to apply to a new job that requires skills they lack or uses an unfamiliar tool. As used herein, a “skill” is an ability to perform a task or operate within a given situation. A “task” is a piece of work to be performed. A skill can specify a proficiency in a software (e.g., a skill in a word processing software), a proficiency in a feature of a software (e.g., a skill in movement modeling within a computer aided design software) a proficiency in a hardware or device (e.g., a skill in utilizing a tool such as a lathe), a proficiency in a software language (e.g., a skill in Visual Basic (e.g., a skill in C programming language), a proficiency with a standard (e.g., a skill related to understanding, operating with respect to, and/or designing in accordance with a standard maintained by a standard organization), a proficiency with a tool (e.g., a skill in utilizing a specified database analysis tool), and/or a proficiency in any other type of task or operation.

In order to learn such new skills, a person can turn to online resources. However, the amount of information on the Internet can be cumbersome as there the Internet enables access to many different documents, videos, tutorials, and further types of content related to many different topics. Filtering through so much content can be tedious, requiring proper search engines and search techniques in order to obtain relevant results. Furthermore, a self-guided user may be inefficient in studying/learning material relevant to assessing whether or not they are proficient in the skill.

Furthermore, entities can make decisions with respect to persons, such as users, employees, or candidates. based on the skills the persons possess. In some cases, an entity requires a person to demonstrate in a live interview setting or a trial that they possess a skill. Scheduling interviews or trials can be difficult due to scheduling conflicts and availability of both the interviewers and interviewees. Without having a way to verify the user possesses the skill, the entity may have to rely on a self-assertion made by the user, which could be ill-informed.

A learning system can offer a centralized resource for learning information, typically through courses. Current learning systems focus on providing broad, generalized learning resources or predefined course paths with limited personalization. These solutions, however, leverage a static content library to identify and present content to a requesting user. Furthermore, existing skill taxonomies have static descriptions of the skills. Such existing learning systems have difficulty adapting to a situation of a user or past proficiencies of the user. For instance, an existing learning system may present material or coursework irrelevant to a role of a user or task goal at hand. Furthermore, in some cases, an existing learning system may present redundant material or coursework below a proficiency level of a user.

Aspects of the present disclosure present an adaptive learning system that generates learning plans utilizing skill data structures. A “learning plan” is used for teaching information related to a skill and assessing a proficiency in the skill. In an aspect, a target goal of a user associated with a user account is received. A target goal has one or more associated skill criterion specifying the respective skills for satisfying or performing the target goal. The user account is determined to fail to satisfy one (or more) of the skill criteria (e.g., the user lacks the skill, or their user account is not assigned an attribution of the skill). A learning plan associated with the skill is generated. The learning plan herein, includes one or more executable modules for assessing if the user satisfies validation criteria corresponding to the skill. An executable module specifies content such as videos, articles, audiobooks, podcasts, graphics, text excerpts, augmented text excerpts that include notes or other additional information, and/or other content that is related to the skill and/or tasks performed utilizing the skill. The executable module further includes assessments for measuring whether or not user interaction with the executable module satisfies criterion of the module. In this context, an assessment is a measure of a proficiency in a task or skill corresponding to the executable module. An assessment can include knowledge checks, questionnaires, quizzes, tests, hands-on labs, practical exercises, portfolio reviews, and/or other measures of proficiency. In an aspect, an executable module comprises code that, when executed by a processor, causes content, material related to labs or other exercises, assessments, and/or other associated material to be presented in a user interface. In another aspect, an executable module is presented in a web page presented in a user interface. A learning plan can automatically track progress in interaction with an executable module and report performance with respect to the executable module.

By generating learning plans in the manners disclosed herein, learning content, assessments, and other learning material is adapted based on a target goal of a user. The learning material is utilized to teach a user a skill, assess a proficiency of the user in the skill, and assign an attribution of the skill to a user account of the user subsequent to the user demonstrating a proficiency that satisfies criteria of the skill or target goal. In this manner, compute resources are conserved by reducing the amount of irrelevant or redundant content presented to a user. Furthermore, this compute resource reduction lowers network traffic, with less content being transmitted between the learning system to the computing device of the user. Still further, the number of processing cycles consumed in loading, processing, and displaying content are also reduced.

Automatic assessment and attribution of skills is also implemented herein through learning plans. As described above, executable modules of a learning plan are utilized to assess a proficiency of a user in a skill. Whether a user account associated with the user satisfies validation criteria corresponding to the corresponding skill is determined. If the assessment system determines the user satisfies the validation criteria, it can assign a “skill attribution” to the user account. The skill attribution can be utilized to attest the user has demonstrated proficiency in the skill. A skill attribution can be maintained in a verifiable storage, such as a ledger database or other secure storage. By automatically assigning skill attributions to a user account in this manner, embodiments of such assessment systems enable secure verification of proficiency of a user in skills. The skill attributions can be utilized to authorize access to resources, generate additional learning plans, mitigate issues in software development, mitigate other software or hardware related issues, and/or perform other skill-based operations based on a skill attributed to a user account described elsewhere herein.

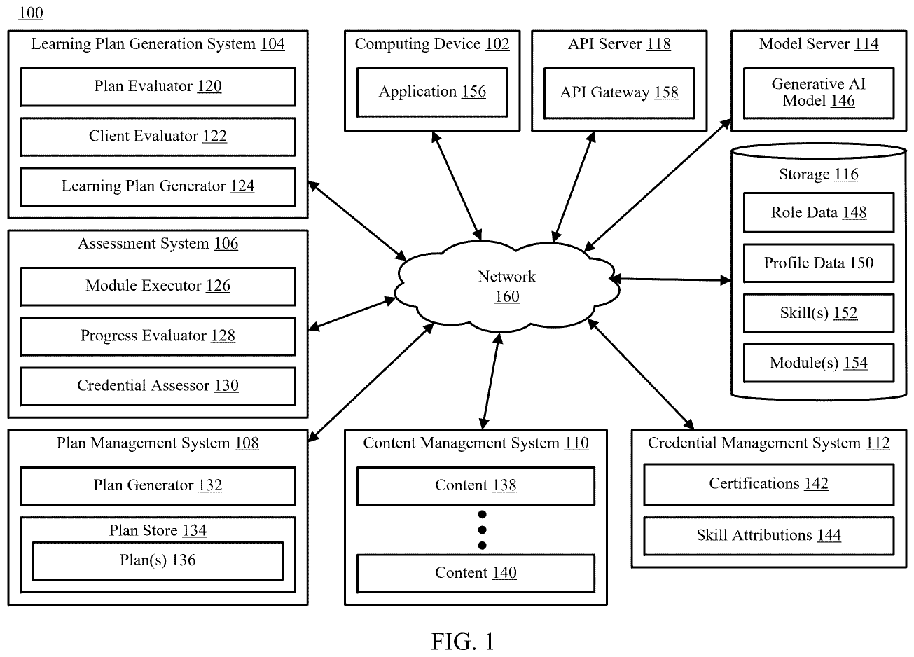

Systems for generating and executing learning plans can be configured in various ways, in embodiments. For instance, FIG. 1 shows a block diagram of a system 100 for learning plan generation and execution, in accordance with an example embodiment. As shown in FIG. 1, system 100 comprises a computing device 102, a learning plan generation system 104, an assessment system 106, a plan management system 108, a content management system 110, a credential management system 112, a model server 114, a storage 116, and an application programming interface (API) server 118. As shown in FIG. 1, computing device 102, learning plan generation system 104, assessment system 106, plan management system 108, content management system 110, credential management system 112, model server 114, storage 116, and API server 118 are communicatively coupled via a network 160. In examples, network 160 comprises one or more networks such as local area networks (LANs), wide area networks (WANs), enterprise networks, the Internet, etc. In examples, network 160 comprises one or more wired and/or wireless portions. The features of system 100 are described in detail as follows.

Storage 116 is any type of physical storage device, including but not limited to, storage disks, solid-state drives (SSDs), random access memory (RAM) devices, flash memory, digital video disks, and/or other types of physical/tangible hardware storage media. Storage 116 stores data generated by and/or obtained by computing device 102, learning plan generation system 104, assessment system 106, plan management system 108, content management system 110, credential management system 112, model server 114, and/or API server 118. As shown in FIG. 1, storage 116 stores role data 148, profile data 150, one or more skills 152 (also referred to as “skills 152” herein), and one or more modules 154 (also referred to as “modules 154” herein).

Role data 148 specifies a role of a person or service. A “role” of a person or service is a function, grouping of functions, responsibility, grouping of responsibilities, or grouping of functions and responsibilities of a person or service. For example, in an embodiment a “security developer user role” specifies a user is a software developer and performs functions such as building secure software systems, developing security measures, designing security solutions, and/or other functions of a software developer. In another example a “model training service role” specifies a service executes operations to train a model such as, hosting a simulation environment, executing a training plan, evaluating a training result, updating a model based on the training result, and/or other operations for training a model. In embodiments, storage 116 can store role data 148 for a single role or many roles. In an embodiment, role data 148 comprises role embeddings that semantically represent a role in vector space.

Profile data 150 specifies information related to a profile of a user account. A “profile” of a user account can specify a username of the account, a name of the user corresponding to the account, a user role of the user, a skill attributed to the user, a certificate attributed to the user, an organization the user is a member of, a type of account of the user account, an industry the user operates within, a title of the user (e.g., a job title, an awarded title, an academic title, etc.), transcript data of the user, other credentials of the user, and/or any other information associated with the user or their user account. In an embodiment, storage 116 can store profile data 150 for a single profile or many profiles. Multiple profiles and/or user accounts can be associated with the same user. For instance, in an embodiment a first profile associated with a user is an “employee profile” corresponding to an account the user has with an organization they work for and a second profile associated with the same user is a “personal profile” corresponding to an account the user utilizes for personal use. In an embodiment, profile data 150 comprises profile embeddings that semantically represent a profile in vector space.

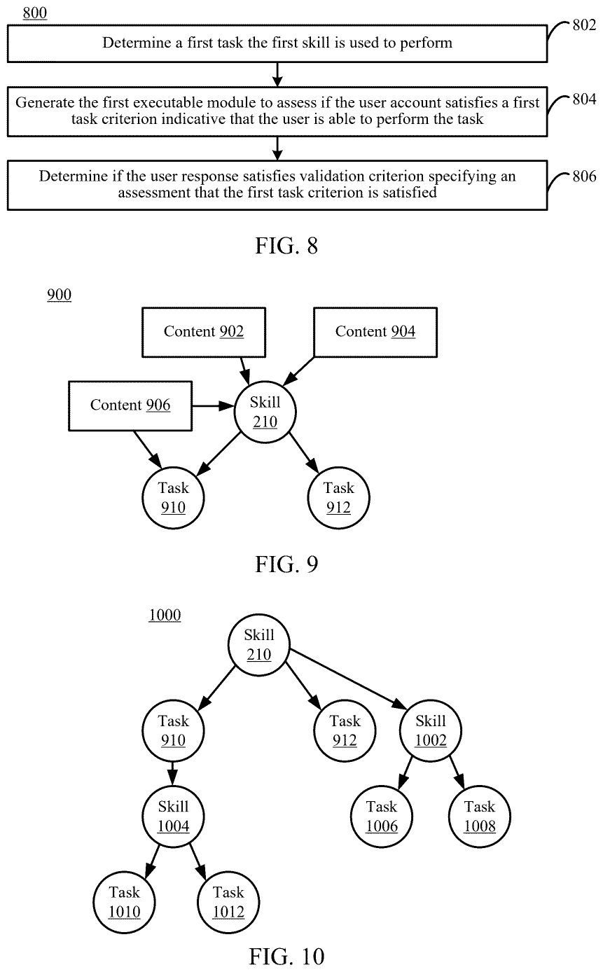

Skills 152 comprise one or more skills. As described elsewhere herein, a “skill” is a representation of an ability to perform a task such as, but not limited to, utilizing a software, utilizing a feature within a software, utilizing a tool, performing an operation, and/or any other type of task described herein. In an embodiment, skills 152 are stored in storage 116 as skill data structures. For instance, in an embodiment, a skill of skills 152 is stored in storage 116 as a skill object model. A skill object model describes a skill, its attributes, and its relationships with content, other skills, tasks, modules, and/or other objects. For instance, a skill object model for a skill can specify content managed by content management system 110 related to the skill, one or more tasks that can be performed with the skill, a certification that requires the skill, an existing module utilized to assess proficiency in the skill, other skills that require a specified degree of proficiency in the skill, other skills with similar assessment criteria, goals that require or otherwise specify the skill, and/or other information related to the modeled skill. In accordance with an embodiment, a skill object model is represented in a directed acyclic graph. Examples of skill object models are further described with respect to FIGS. 8, 10, and 11, as well as elsewhere herein.

Modules 154 comprise one or more executable modules. As described herein, executable modules present information corresponding to a skill and assess if validation criterion of a skill or task is satisfied. A module of modules 154 can comprise video content of the module, image content of the module, text content of the module, instructions for a lab associated with the module, example code or other content associated with the lab, an assessment, executable code that upon execution presents content or other portions of the module, a uniform resource locator (URL) of a website associated with the module, and/or other information related to the module. Modules 154 can specify a learning plan the modules are associated with, a skill or task a module is utilized to teach or otherwise assess, a user account the module was created on behalf of, and/or other information with respect to modules of module 154. In an embodiment, modules 154 are mapped to corresponding skills of skills 152.

Computing device 102 is any type of stationary or mobile processing device, including, but not limited to, a desktop computer, a server, a mobile or handheld device (such as a tablet, a personal data assistant (PDA), a smart phone, a laptop, etc.), an Internet-of-Things (IoT) device, etc. In accordance with an embodiment, computing device 102 is associated with a user (such as an individual user, a group of users, an organization, a family user, a customer user, an employee user, an admin user (such as a service team user, a developer user, a management user, etc.), etc.). As shown in FIG. 1, computing device 102 executes an application 156. Application 156 is a type of application for searching for learning material, executing learning plans, performing assessments, developing programs, and/or performing other operations as described elsewhere herein. In an embodiment, application 150 can be used for interfacing with learning plan generation system 104, assessment system 106, plan management system 108, content management system 110, credential management system 112, model server 114, storage 116, and/or API server 118.

API server 118 and model server 114 are network-accessible servers or other types of computing devices. In accordance with an embodiment, one or more of API server 118 and/or model server 114 are incorporated in a network-accessible server set (such as a cloud-based environment, an enterprise network server set, and/or the like). In an embodiment, and as shown in FIG. 1, API server 118 and model server 114 are implemented as single servers. Alternatively, API server 118 and/or model server 114 are implemented across multiple servers or computing devices (such as in a distributed server implementation) or integrated into a single server. Each of API server 118 and model server 114 are configured to execute services and/or store data. For instance, as shown in FIG. 1, API server 118 hosts an API gateway 158 and model server 114 hosts a generative AI model 146. In an embodiment, application 156 interfaces with API gateway 158 and/or generative AI model 146.

API gateway 158 is a service configured to facilitate communication between a front end system and a back end system. For instance, API gateway 158 in an embodiment facilitates communications between application 156 and “back end” systems such as learning plan generation system 104, assessment system 106, plan management system 108, content management system 110, credential management system 112, storage 116, and/or generative AI model 146. In an embodiment, API gateway 158 exposes one or more APIs that application 156 can utilize to cause functions of a back end system to be performed.

As shown in FIG. 1, model server 114 hosts generative AI model 146. Generative AI model 146 is a large language model (LLM). Generative AI model 146 is trained on a corpus of information to generate learning plans. For instance, in an embodiment, generative AI model 146 is a model trained to teach concepts (e.g., skills, tasks, groupings thereof and/or portions thereof). In this context, generative AI model 146 is trained on existing teaching data. Examples of teaching data include, but are not limited to, syllabus information for a course, instructional videos for subjects, example exams, example quizzes, lesson plans, graded coursework, textbooks, workbooks, study guides, and/or other data related to teaching. In some embodiments, generative AI model 146 is trained on teaching data within a domain (e.g., a database development domain, a computer science domain, a software engineering domain, an electrical engineering domain, a content creation domain, a web development domain, and/or other domains). In another alternative embodiment, generative AI model 146 is trained on a (e.g., very large) corpus of information to generate output based on prompted input.

Learning plan generation system 104 is a computer-implemented system that generates learning plans. In embodiments, learning plan generation system 104 can be implemented on a single computing device (e.g., a single server or as part of a client computing device) or on multiple computing devices (e.g., multiple servers, a client computing device and one or more servers, etc.). As shown in FIG. 1, learning plan generation system 104 comprises a plan evaluator 120, a client evaluator 122, and a learning plan generator 124, each of which are implemented as sub-services and/or subcomponents of learning plan generation system 104. Plan evaluator 120 comprises logic to evaluate goal information related to a target goal of a user account. For instance, plan evaluator 120 can access role data 148 of storage 116, plan management system 108, and/or other information to determine skill criterion specifying required skills to satisfy a target goal. The target goal can be a task or workload a user associated with the account has been assigned or otherwise intends to perform, a job position the user intends to apply to, a certification the user intends to apply for, a certification required to perform a task, and/or another type of goal of a user that a skill can be used to reach or otherwise fulfill.

Client evaluator 122 comprises logic to evaluate a user that intends to satisfy the target goal. Client evaluator 122 determines if the user satisfies criteria of the target goal and identifies any deficiencies (if any). In an aspect, client evaluator 122 evaluates profile data of profile data 150 associated with the user, as well as any attributed skills of the user to determine if the user is deficient in satisfying the target goal.

Learning plan generator 124 comprises logic to generate a learning plan for teaching and assessing one or more skills. In an embodiment, learning plan generator 124 generates a learning plan to teach skills a user is deficient in, e.g., as determined by client evaluator 122. Learning plan generator 124 can leverage generative AI model 146 in generating a learning plan tailored to a user or situation. For instance, learning plan generator 124 can utilize generative AI module 146 to determine a learning objective for content, validate the learning objective, and generate a set of questions for assessing a proficiency in the fulfilling the learning objective. In an embodiment, the learning plan generated by learning plan generator 124 includes one or more modules for assessing proficiency in a skill. In an embodiment, learning plan generator 124 divides a skill into a set of tasks. A skill can define each task. A task represents a portion of a skill, an operation that can be performed using the skill, or a certain level of proficiency with a skill. In an embodiment, a learning plan comprises a module for each task of a skill.

Assessment system 106 is a computer-implemented system that manages execution of learning plans and assessment of learning plan results. In embodiments, assessment system 106 can be implemented on a single computing device or multiple computing devices. In embodiments, assessment system 106 (or a subcomponent thereof) is configured to determine if a user has demonstrated a proficiency in a task or skill. The criteria utilized by assessment system 106 can be manually determined by a psychometrician, subject matter expert, or other type of authoritative user or group of users. Alternatively, the criteria is semi-automatically or automatically determined by a model. As shown in FIG. 1, assessment system 106 comprises a module executor 126, a progress evaluator 128, and a credential assessor 130, each of which are implemented as sub-services and/or subcomponents of assessment system 106. Module executor 126 comprises logic to cause a module of a learning plan to be executed. In an aspect, module executor 126 executes the module. Alternatively, module executor 126 transmits a module to an external device (e.g., computing device 102) for execution thereof.

Progress evaluator 128 comprises logic to analyze progress a user has made in responding to and/or otherwise interacting with modules of a learning plan. In an embodiment, progress evaluator 128 receives responses indicative of interaction with a module. Alternatively, or additionally, progress evaluator 128 monitors activity logs associated with the module or device executing the module.

Credential assessor 130 comprises logic to assess a performance of a user with respect to a module. For example, credential assessor 130 evaluates whether or not responses to a knowledge check of a module are correct and/or if a percentage of correct responses satisfies an assessment criterion. A knowledge check is a type of assessment for assessing proficiency with respect to a concept. A knowledge check can be a question, quiz, test, practical exercise, and/or any other type of assessment. In an embodiment, a knowledge check is relatively short and directed to a subset of material covered by a module. If the assessment criterion is not satisfied, credential assessor 130 causes the module (or learning plan) to be reset and caused to be executed. In an alternative where the assessment criterion is not satisfied, credential assessor 130 causes learning plan generator 124 to generate a new module or learning plan for the user to reattempt learning deficiencies. If the assessment criterion is satisfied, credential assessor 130 can cause a skill attribution to be assigned to a user account of the user, the skill attribution indicating the user has demonstrated proficiency in the skill.

Plan management system 108 is a computer-implemented system that manages plans. In embodiments, plan management system 108 can be implemented on a single computing device or multiple computing devices. As shown in FIG. 1, plan management system 108 comprises a plan generator 132 and a plan store 134. Plan generator 132 is a sub-service or subcomponent of plan management system 108 and comprises logic to generate plans for satisfying goals. Plans generated by plan generator 132 can specify skills and/or other requirements to fulfill the target goal, tasks to perform to fulfill the target goal, a recommended order in learning skills and/or fulfilling other requirements, and/or any other information related to fulfilling goal criteria of the target goal. In an embodiment, plan generator 132 exposes an API that enables a user to manually generate or modify a plan. Alternatively, or additionally, plan generator 132 utilizes a generative AI model to generate a plan based on a target goal. As described herein, plan evaluator 120 can utilize plans generated by plan generator 132 to determine requirements to be taught by a learning plan in order to satisfy the target goal. In an embodiment, plans are generated ahead of time or offline from user requests to fulfill a target goal. Alternatively, plan generator 132 generates a plan responsive to a user request to fulfill a target goal.

Plan store 134 is data store configured to store one or more plans 136 (“plans 136” herein). In an embodiment, plans 136 are generated and/or managed by plan generator 132. While plan store 134 is shown as a subcomponent of plan management system 108 in FIG. 1, embodiments described herein are not so limited. For instance, in an embodiment, plan store 134 is incorporated within storage 116. In another embodiment, plan store 134 is a separate storage external to plan management system 108.

Content management system 110 is a computer-implemented system that manages content. In embodiments, content management system 110 can be implemented on a single computing device or multiple computing devices. Content management system 110 comprises or executes logic to obtain, manage, and/or store content 138-140. In accordance with an embodiment, content management system 110 stores some or all of content 138-140 in storage 116. Content 138-140 represents content associated with system 100. Content of content 138-140 can be content generated by components of system 100, content obtained by components of system 100, content stored by components of system 100, and/or any other type of content associated with system 100. Examples of content include, but are not limited to, articles, data files, videos, graphics, websites, books, journals, blogs, forums, virtual lessons, podcasts, audiobooks, music files, text documents, scanned documents, workload logs, and/or other media comprising information. In an embodiment, content management system 110 obtains content 138-140 by crawling one or more websites for information. In another example, users provide content 138-140 to content management system 110 for storage thereof, e.g., through interaction with application 156. In an embodiment, content of content 138-140 is mapped to a skill of skills 152, indicating a piece of content is associated with the skill, discusses the skill, provides examples of tasks utilizing the skill, and/or is otherwise related to the skill. Content managing system 110 in an example embodiment generates tags and associates the tags with content of content 138-140 indicating attributes of the content such as, but not limited to, a corresponding skill, semantically similar content, introductory versions of the content, a recommended skill prior to reviewing the content, and/or other attributes of the content. In this manner, systems described herein can leverage the tags in determining whether or not to access or utilize the content. For instance, in an embodiment, learning plan generator 124 can utilize tags to determine which content to use in generating a learning plan.

Content managing system 110 associates content 138-140 with skills in various ways. For instance, in an embodiment, content managing system 110 analyzes keywords or key phrases of content to determine if it is related to a skill. For instance, a list of keywords or key phrases can be associated with a skill of skills 152. In this example, content managing system 110 scans or otherwise analyzes a piece of content to determine if it is relevant to the skill (e.g., a number of instances of key words in the list satisfies a relevancy criterion, a number of different types of key words satisfies a relevancy criterion, etc.). If so, content management system 110 flags or otherwise indicates the content is relevant to the skill.

In an embodiment, content managing system 110 utilizes an embedding model (e.g., a model of model server 114 or another model) to identify content related to a skill. Embeddings are information dense representations of semantic meaning of an input (e.g., a piece of text). For example, in accordance with an embodiment, an embedding is a vector of floating-point numbers such that the distance between two embeddings in vector space is correlated with the semantic similarity between two inputs in their original format (e.g., text format). As an example, if two texts are similar, their vector representations should also be similar. In an embodiment, vectors are considered semantically similar if their values match above a certain percentage (e.g., above 50%, above 90%, and/or the like). In another embodiment, vectors are considered semantically similar if the distance between them is within a predetermined threshold distance. In another example, two vectors within a group of multiple (e.g., three or more) vectors are considered semantically similar if they are closer to each other in vector space than any other vector in the group, a majority of other vectors in the group, or at least one other vector in the group. In these manners, embeddings generated by an embeddings model provide representation of data usable by systems described herein for determining a level of similarity between pieces of information. For instance, in an embodiment, content management system 110 utilizes embeddings representative of a skill and embeddings representative of content 138 to determine if a level of similarity between content 138 and the skill satisfies a similarity criterion. If so, content management system 110 can tag, flag, or otherwise associate content 138 with the skill. In this manner, content management system 110 identifies content related to skills that can be utilized by learning plan generator 124 in generating learning plans for teaching or otherwise assessing proficiency in the skill.

In an embodiment, content management system 110 comprises logic for reviewing associations between content and skills. For instance, in an automatic review aspect, content management system 110 automatically flags content as potentially related to a skill based on keyword searching. Flagged content is later further reviewed to determine if a positive match between the content and the skill has been made. In a non-limiting example, further review is performed by utilizing an embeddings model to generate embeddings for the flagged content and the skill. If a level of similarity between the embeddings satisfies a similarity threshold, the content is associated with the skill. In this manner, content management system 110 can flag content utilizing fewer compute resources in parallel with searching and website crawling operations and further analyze (e.g., only) flagged content with analysis methods such as embeddings comparisons. Furthermore, this type of tagging and further review reduces the amount of compute resources expended by the embeddings model and the amount of network traffic between the embeddings model and content management system 110, as (e.g., only) tagged content is provided to the embeddings model without causing embeddings model to generate embeddings for all crawled content.

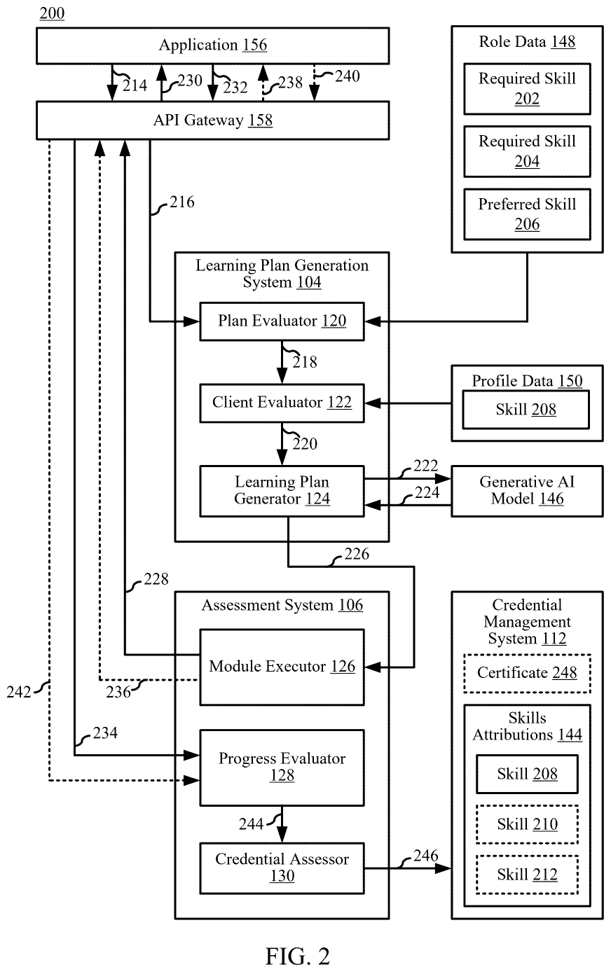

Credential management system 112 is a computer implemented system that manages credentials. In embodiments, credential management system 112 can be implemented on single computing device or multiple computing devices. Credential management system 112 comprises or executes logic to maintain attributions of certificates and/or skills, validate credentials, and/or handle credential query requests. In this example, “credentials” refers to certifications, skills, and/or other qualifications attributed to a user account (or, in an alternative, a service). Credential management system 112 operates as a trusted authority for maintaining and validating credentials. As shown in FIG. 1, credential management system 112 manages certifications 142 and skill attributions 144. In an embodiment, certifications 142 comprises mappings of certifications to user accounts and skill attributions 144 comprises mappings of skills of skills 152 to user accounts, models, and/or services. In an aspect, credential management system 112 receives requests from another service, component, or user account to verify or otherwise attest certifications or skills attributed to a user account, service, or model. An example where credential management system 112 verifies credentials of a user account is further described with respect to FIGS. 6 and 7, as well as elsewhere herein. In another aspect, credential management system 112 receives requests to attribute a certificate or skill to a user account, service, or model. Examples of attributing skills and/or certificates to user accounts, services, and/or models are described with respect to FIGS. 2, 4, 5, 14, 15, 18, and 20, as well as elsewhere herein.

Embodiments of learning plan generation system 104 and assessment system 106 are configured to generate and execute learning plans in various ways. For instance, FIG. 2 shows a block diagram of a system 200 for learning plan generation and execution, in accordance with another example embodiment. As shown in FIG. 2, system 200 comprises learning plan generation system 104 (comprising plan evaluator 120, client evaluator 122, and learning plan generator 124), assessment system 106 (comprising module executor 126, progress evaluator 128, and credential assessor 130), credential management system 112, generative AI model 146, role data 148, profile data 150, application 156, and API gateway 158 as described with respect to FIG. 1. As further shown in FIG. 2, credential management system 112 manages skill attributions 144 and a certificate 248, role data comprises a required skill 202, a required skill 204, and a preferred skill 206, and profile data 150 comprises a skill 208. Skill attributions 144 comprise attributions of skills 208, 210, and skill 212. In an embodiment, certificate 248 is a certification requiring one or more of skills 208, 210, and/or skill 212. Credential management system 112 can further map certificate 248 and/or skills of skill attributions 144 to profiles that are attributed to the respective certificate and/or skill. In an embodiment, required skills 202 and 204 are skills required to fulfill skill criteria of a role corresponding to role data 148 and skill 206 is a preferred skill of the role. In an embodiment, possessing skill 206 satisfies a second skill criterion of the role. Skill 208 of profile data 150 indicates the user account associated with profile data 150 is attributed skill 208. In an embodiment, the attribution is maintained by credential management system 112.

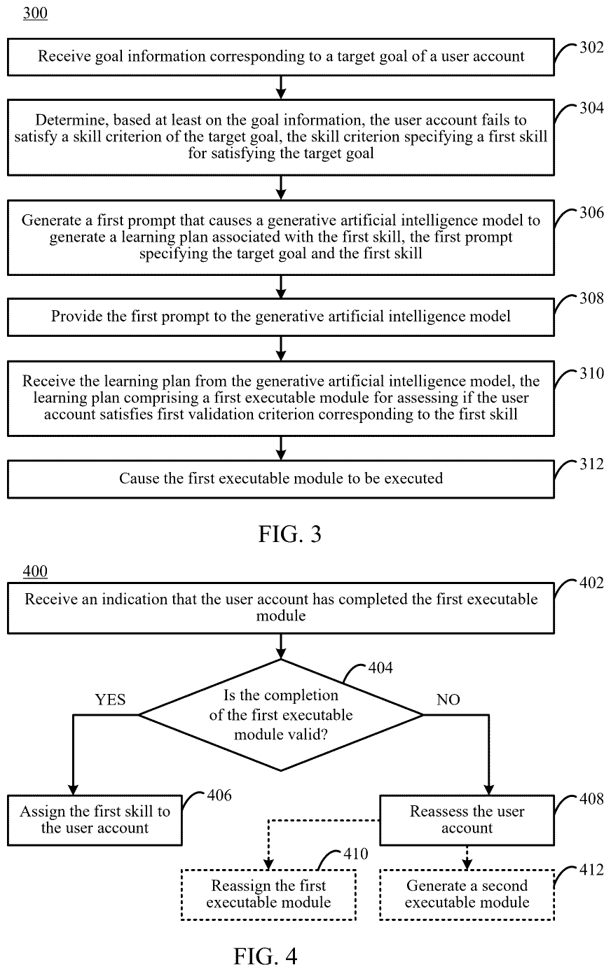

To better understand the operation of learning plan generation system 104 of FIG. 2, system 200 is described with respect to FIGS. 3 and 4. FIG. 3 shows a flowchart 300 of a process for learning plan generation and execution, in accordance with an example embodiment. In an embodiment, learning plan generation system 104 of FIG. 2 operates according to one or more steps of flowchart 300. Note that not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, goal information corresponding to a target goal of a user or a user account is received. For example, plan evaluator 120 of FIG. 2 receives goal information 216 corresponding to a target goal of a user account. In an embodiment, API gateway 158 provides goal information 216 responsive to a learning request 214 received from application 156. In this context, learning request 214 specifies an intended goal of a user or their account. For instance, learning request 214 can specify a role the user intends to apply for, a certification the user intends to achieve, a tool the user intends to utilize, an advance course the user intends to take, an operation the user intends to perform, and/or any other type of goal a user intends to achieve or otherwise fulfill. In embodiments, plan evaluator 120 can obtain goal information in alternative to or in addition to information included in request 214. For instance, as shown in FIG. 2, plan evaluator 120 can access role data 148 that specifies requirements of a role. In this non-limiting role application example, goal information 216 specifies a role a user desires and the additional goal information obtained from role data 148 specifies skills 202 and 204 that are required to perform the role and skill 206 that is a preference in performing the role. In a non-limiting tool example, plan evaluator 120 determines goal information specifying a tool required to perform a project and a skill required to use the tool. As shown in FIG. 2, plan evaluator 120 provides determined plan information 218 to client evaluator 122. Plan information 218 comprises requirements to satisfy criterion of the target goal.

In step 304, the user account is determined, based at least on the goal information, to fail to satisfy a skill criterion of the target goal, the skill criterion specifying a first skill for satisfying the target goal. For example, client evaluator 122 determines a user account corresponding to profile data 150 fails to satisfy a skill criterion of plan information 218, the skill criterion specifying skill 204 is required to satisfy the target goal. In embodiments, client evaluator 122 can also determine skills a user does possess. For instance, in the non-limiting role application example described with respect to step 302 and shown in FIG. 2, the user account is determined to be attributed skill 208, which is a further example of required skill 202; however, in this example, the user account fails to possess an attribution of required skill 204. In the non-limiting tool example described with respect to step 302, the user is determined to not possess or be attributed to the skill required to use the tool. In embodiments, and as shown in FIG. 2, client evaluator 122 provides a client evaluation result 220 (“result 220”) to learning plan generator 124 indicative of deficiencies the user account has in satisfying the target goal and, optionally, attributions of proficiencies the user account possesses.

In step 306, a first prompt that causes a generative AI model to generate a learning plan associated with the first skill is generated, the first prompt specifying the target goal and the first skill. For example, learning plan generator 124 generates a prompt 222 (“prompt 222” herein) based on result 220. Prompt 222 specifies the target goal corresponding to goal information 216 and the skill the user fails to possess (e.g., skill 204 in the role application example). Prompt 222 comprises instructions that cause generative AI model 146 to generate a learning plan associated with the skill. In an embodiment, the instructions further specify that generative AI model 146 is to generate the learning plan as if it were an instructor. In an aspect, prompt 222 provides examples of an instructor in a similar domain as the target goal. In another aspect, prompt 222 provides example lesson plans of an instructor in the similar domain. In an aspect further described in Section VI. Sub-section E, “Content Generation Embodiments,” prompt 222 comprises instructions to generate and organize content associated with the skill. In the non-limiting role application example described with respect to steps 302 and 304, prompt 222 specifies the role and skills 202 and 204 to perform or apply for the role, with skill 202 already being possessed by the user and attributed to the user account of the user. In a further aspect of this non-limiting example, prompt 222 specifies preferred skill 206 as an optional skill to learn. In the non-limiting tool example described with respect to steps 302 and 304, prompt 222 specifies the project, the tool required to perform the project, and the skill to use the tool.

In step 308, the first prompt is provided to the generative AI model. For example, learning plan generator 124 of FIG. 2 provides prompt 222 to generative AI model 146, causing generative AI model 146 to generate a learning plan 226. In an embodiment, prompt 222 causes generative AI model 146 to generate learning plan 226 by generating one or more executable modules. The executable modules can be used for assessing if the user satisfies validation criterion for a skill or task of a skill. Validation criteria can specify a variety of criterion for determining whether or not a user has demonstrated proficiency in the skill such as, but not limited to, a percentage of questions in a test answered correctly, an amount of time spent reviewing content, a measure of a written (e.g., handwritten or typed) response to a prompt or question, and/or another criterion for determining whether or not a user has demonstrated proficiency in the skill. A learning plan can have one executable module or multiple modules. In examples where multiple modules are generated, a learning plan can specify an order in which the modules are to be performed, if there is any order. In examples, the specified order can be a recommendation or an enforced order that restricts progression of one module without completion of a “parent” module. Modules can comprise instructions for teaching a skill. The instructions can include videos, images, other graphics, text excerpts, and/or other material for teaching a skill or task. In some embodiments, generative AI model 146 augments existing material with notes and/or excerpts of other materials. For instance, generative AI model 146 in an embodiment generates an article describing a task based on excerpts from a website or journal article and augments the excerpts with comments and/or other notes based on other excerpts of other websites and/or articles related to the task. In another example, generative AI model 146 inserts pop-up notes in a video describing a skill, where the pop-up notes are generated from other websites, articles, videos, or other material related to the skill and add additional concept to respective portions of the video.

In step 310, the learning plan is received from the generative AI model, the learning plan comprising a first executable module for assessing if the user satisfies first validation criterion corresponding to the first skill. For example, learning plan generator 124 receives learning plan 226 in a response 224 from generative AI model 146. Learning plan 226 comprises at least a first executable module for assessing if the user satisfies validation criterion corresponding to the first skill (e.g., skill 204 in the non-limiting role application example). In an example implementation, an executable module of learning plan 226 comprises content generated and/or organized by generative AI model 146 and associated with teaching the first skill. In an embodiment, learning plan generator 124 validates the executable module by determining if the module can be successfully executed, determining a level of similarity between the module and the target goal satisfies a similarity validation criterion, performing a semantic and syntax evaluation on the executable module, checking grammar of the module, and/or performing other operations to validate whether or not the module is suitable for teaching and assessing a skill and/or task.

In step 312, the first executable module is caused to be executed. For example, learning plan generator 124 of FIG. 2 provides learning plan 226 to module executor 126, causing module executor 126 to execute or otherwise cause execution of learning plan 226 and/or one or more modules of learning plan 226. As shown in FIG. 2, module executor 126 provides learning plan 226 to API gateway 158 via execution instructions 228 (“instructions 228”) and API gateway 158 provides corresponding instructions 230 to application 156. In an embodiment, instructions 230 cause application 156 to execute learning plan 226. For instance, application 156 executes an executable module of learning plan 226 subsequent to receiving instructions 230. In an alternative embodiment, instructions 230 cause application 156 to present an option to execute the module in a UI of computing device 102. In an embodiment where learning plan 226 comprises multiple modules, instructions 228 and 230 can comprise multiple or all of the modules. Alternatively, modules can be sent in separate sets of instructions. For instance, as optionally shown in FIG. 2, second instructions 226 can be sent to API gateway 258, causing API gateway 158 to transmit instructions 238 to application 156. Instructions 226 and 238 in this optional embodiment comprise in instructions to execute a second module of learning plan 226. In an embodiment, module executor 126 causes instructions 236 to be sent subsequent to assessment system 106 receiving an indication that the first module is completed.

In an embodiment, execution of the module further causes performance of a user to be assessed. In an aspect, if the performance of the user passes assessment, the skill is assigned to the user, e.g., as further described with respect to FIG. 4, as well as elsewhere herein. In another aspect, a target goal is automatically fulfilled or caused to be performed based on successful assessment. For instance, in the non-limiting tool example described with respect to steps 302-306, subsequent to successful assessment, systems described herein can cause the project to be performed. For instance, in an aspect, systems described herein can automatically cause the a software tool for performing the project to be launched on a computing device associated with the user, automatically grant a license to a software tool for performing the project to the user account, automatically prepare data for performing the project, transmit a notification to the user account or user computing device indicating the user account is assigned the skill and is able to perform the project, and/or otherwise perform actions related to the project. As another example with respect to the non-limiting role application example described with respect to steps 302-306, subsequent to successful assessment, systems described herein can cause an application for the role to be submitted on behalf of the user, a recommendation for the role to be transmitted to the user account, and/or other actions related to applying for a role.

As described herein, assessment system 106 is configured to assess a proficiency of a user in a skill and manage assignment of skills to user accounts. To better understand the operation of assessment system 106 of FIG. 2, system 200 is further described with respect to FIG. 4. FIG. 4 shows a flowchart 400 of a process for assessing module execution performance, in accordance with an example embodiment. In an embodiment, assessment system 106 of FIG. 2 operates according to one or more steps of flowchart 400. Note that not all steps of flowchart 400 need be performed in all embodiments. Further structural and operational embodiments will be apparent to persons skilled in the relevant art(s) based on the following descriptions of FIGS. 2 and 4.

In step 402, an indication that the user account has completed the first executable module is received. For example, progress evaluator 128 receives an indication 234 that the user account has completed the first executable module of learning plan 226. In an embodiment, indication 234 comprises results of a summative assessment made by the executed module. A summative assessment is a measure of the user's overall proficiency in the skill or task corresponding to the executed module. For example, a summative assessment can include a test, questionnaire, quiz, practical exercise, and/or other type of assessment intended to measure a user's proficiency with respect to concepts taught by the executed module. In another embodiment, indication 234 comprises response results and/or interaction results of user interaction with knowledge checks and other interactable elements of the executed module. API gateway 158 generates or provides indication 234 responsive to application 156 generating a module complete signal 232. As shown in FIG. 2, progress evaluator 128 provides module completion information 244 specifying the results of the user completing the module. In an aspect, progress evaluator 128 verifies indication 234 is correct, complete, and/or otherwise a valid indication. In situations where multiple modules are executed, indication 234 comprises indications that each of the modules are complete. Alternatively, separate indications are received for multiple models. For instance, as shown in FIG. 2, progress evaluator 128 can receive an indication 242 with respect to a different module of the learning plan and responsive to application 156 generating a module complete signal 240 corresponding to the different module.

In step 404, a determination of whether the completion of the first executable module is valid is made. For example, credential assessor 130 of FIG. 2 determines whether completion of the executable module is valid. In an example, credential assessor 130 determines whether or not summative assessments of the completed modules indicate module completion criterion was satisfied. In another embodiment, credential assesses whether or not a percentage or number of correct responses to questions of the module satisfies an assessment criterion. If the completion of the first executable module is valid, flowchart 400 proceeds to step 406. Otherwise, flowchart 400 proceeds to step 408. In an implementation where credential assessor 130 determines if completion of multiple modules is valid, flowchart 400 proceeds to step 406 if completion of each of the modules is valid. If completion of one or more modules is invalid, e.g., a summative assessment corresponding to one or more modules is invalid, flowchart 400 proceeds to step 408.

In step 406, the first skill is assigned to the user account. For example, credential assessor 130 of FIG. 2 assigns the user account the skill the learning plan teaches responsive to determining the assessment criterion is satisfied by the completion of the module. As shown in FIG. 2, credential assessor 130 provides an assignment signal 246 that causes credential management system 112 to generate and/or store an attribution of the skill to the user account in skills attributions 144. For instance, if assignment signal 246 indicates skills 210 and/or 212 are to be attributed to the user account, credential management 112 stores a mapping of the skills to the user account in skills attributions 144. In an embodiment, assignment signal 246 comprises a verifiable token or identifier of credential assessor 130 that attests assignment signal 246 is generated by and sent on behalf of credential assessor 130. In this aspect, credential management system 112 verifies the verifiable token or identifier prior to updating skills attributions 144. In an embodiment where certificate 248 specifies one or more skills required for certification, credential assessor 130 can also assign the certificate to the user account. For instance, suppose certificate 248 requires possession of skills 208 and skill 210, the user account already possesses an attribution of skill 208, and learning plan 226 teaches skill 210. In this example, credential assessor 130 generates assignment signal 246 comprising instructions to map the attribution of skill 210 to the user account and certificate 248 to the user account. In some embodiments, the mapping of certificate 248 to the user account is a preliminary association. In this context, a certificate authority reviews the preliminary association and determines whether or not to approve the assignment.

In embodiments described herein, credential assessor 130 can attribute a skill to a user account in a binary sense (e.g., either the user or service possesses the skill or does not possess the skill) or a degree of proficiency. For example, credential assessor 130 can attribute a skill to a user account based on the number of different types of tasks the associated user can perform with the skill, the type of different type of tasks the user can perform with the skill, and/or another manner of measuring the level at which the user is capable of utilizing the skill. For instance, in an example, if a user has demonstrated ability in performing a first set of tasks utilizing a skill, credential assessor 130 assigns the user account of the user a “basic” or “low” proficiency in the skill. If the user has demonstrated ability in performing a second set of tasks utilizing the skill, credential assessor 130 assigns the user account of the user an “intermediate” or “medium” proficiency in the skill. If the user has demonstrated an ability in performing a third set of tasks utilizing the skill, credential assessor 130 assigns the user account of the user an “advanced” or “high” proficiency in the skill. While these three different levels are described, embodiments described herein can break up and assign various degrees of proficiency in a skill in a variety of ways (e.g., based on categorical levels, based on a numerical degree, and/or the like).

In step 408, the user account is reassessed. For example, credential assessor 130 assesses the user account for proficiency of a corresponding user in skills. In an embodiment, credential assessor 130 causes the first executable module to be reassigned to the user account and executed by module executor 126 (e.g., in step 410). Alternatively, in step 412, credential assessor 130 causes a second executable module to be generated by learning plan generator 124. For instance, credential assessor 130 can determine the first module is unsuitable for teaching the user the skill. Credential assessor 130 can make this determination based on one or more factors including, but not limited to, the user failing to satisfy criteria of the first module more than a predetermined number of times, the user failing to satisfy the criteria by a predetermined amount, or credential assessor 130 identifying a potential improvement opportunity in the module.

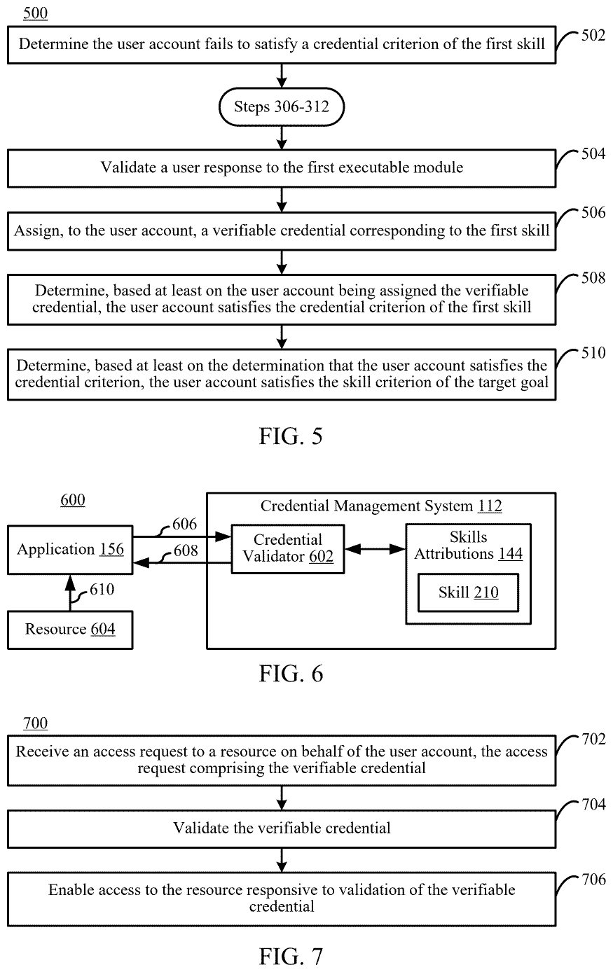

Embodiments of the present disclosure generate and assess performance of learning plans in various ways, in embodiments. For instance, credential management system 112 manages attributions of skills and utilizes verifiable credentials to verify whether or not a user account is attributed to that skill. Systems leveraging this function of credential management system 112 operate in various ways. For example, FIG. 5 shows a flowchart 500 of a process for assessing skill criterion, in accordance with another example embodiment. In an embodiment, learning plan generation system 104 and assessment system 106 of FIG. 2 operate according to one or more steps of flowchart 500. Note that not all steps of flowchart 500 need be performed in all embodiments. Further structural and operational embodiments will be apparent to persons skilled in the relevant art(s) based on the following description of FIG. 5 with respect to FIG. 2.

Flowchart 500 begins with step 502, which is a further example of step 304 of flowchart 300 of FIG. 3, in an embodiment. In step 502, the user account is determined to fail to satisfy a credential criterion of the first skill. For example, in an embodiment, client evaluator 122 determines the user account fails to satisfy a credential criterion of the first skill. In this context, client evaluator 122 accesses profile data 150 to determine if the profile possesses credentials. If so, client evaluator 122 requests credential management system 112 to verify the credentials. If the credentials are valid, client evaluator 122 determines the user possesses the corresponding skill. If the credentials are not valid or the profile does not possess credentials, client evaluator 122 determines the user fails to possess the skill.

As shown in FIG. 5, flowchart 500 continues with steps 306-312 of flowchart 300, as described with respect to FIG. 3.

Flowchart 500 continues with step 504. Step 504 is a further example of steps 402 and 404 of flowchart 400 of FIG. 4, in an embodiment. In step 504, a user response to the first executable module is validated. For example, as described with respect to steps 402 and 404 of flowchart 400 of FIG. 4, progress evaluator 128 receives indication 234 and credential assessor 130 validates the completion of the executable module.

Flowchart 500 continues with step 506, which is a further example of step 406 of flowchart 400 of FIG. 4, in an embodiment. In step 506, a verifiable credential corresponding to the first skill is assigned to the user account. For example, credential assessor 130 provides assignment signal 246 to credential management system 112. In this example, assignment signal 246 causes credential management system 112 to assign a verifiable credential corresponding to the skill (e.g., skill 210) to the user account. In an example, the verifiable credential is generated and digitally signed by credential assessor 130 with a private cryptographic key of a key pair that enables other services or devices to utilize a corresponding public cryptographic key to verify the signature. Alternatively, the verifiable credential is generated and digitally signed by credential management system 112. In another embodiment, the verifiable credential is maintained by credential management system 112 in a mapping between the verifiable credential and the user account such that credential management system 112 provides an indication that the user account possesses the credential in response to verification request.

In step 508, the user account is determined to satisfy the credential criterion of the first skill based at least on the user account being assigned the verifiable credential. For example, client evaluator 122 (or another component of learning plan generation system 104 and/or assessment system 106) determines the user account satisfies credential criterion of skill 210 based at least on the user account being assigned the verifiable credential. For instance, in an embodiment, client evaluator 122 receives the verifiable credential from credential management system 112 and utilizes a public cryptographic key to determine a signature of the credential matches a signature of credential assessor 130 or credential management system 112. Alternatively, client evaluator transmits a request to credential management system 112 for an indication of whether or not the user account is assigned the verifiable credential.

In step 510, the user account is determined to satisfy the skill criterion of the target goal based at least on the determination that the user account satisfies the credential criterion. For example, client evaluator 122 (or another component of learning plan generation system 104 and/or assessment system 106) determines the user account satisfies skill criterion of the target goal based at least on the determination that the user account satisfies the credential criterion.

### III. Skill-Based Resource Access Embodiments

Skills attributions to a user account can be utilized in a variety of ways, in embodiments. For instance, skills can be used to regulate access to resources in a computing system. Systems for implementing skill-based resource access policies can be configured in various ways, in embodiments. For example, FIG. 6 shows a block diagram of a system 600 for skill-based resource access, in accordance with an example embodiment. As shown in FIG. 6, system 600 comprises credential management system 112 and application 156, as described with respect to FIG. 1, as well as a resource 604. As further shown in FIG. 6, credential management system 112 manages skill attributions 144 (comprising attribution of skill 210) as described with respect to FIGS. 1 and 2 and executes a credential validator 602. Credential validator 602 is configured to validate credentials of user accounts, services, and/or models.

Resource 604 is a resource of a computing system. Examples of resources include, but are not limited to, data files, a data store, a virtual machine, a hardware component, a computing device, an application, and/or another virtual or physical resource of a computing network. In accordance with an embodiment, access to resource 604 is restricted by an access-policy. The access-policy can specify various access criterion a user account has to satisfy in order to access and/or otherwise utilize resource 604. Examples of access criterion include, but are not limited to, a skill required to access or utilize the resource, a level of privileges required to access or utilize the resource, a role required to access or utilize the resource, a certification required to access or utilize the resource, an attestation required to access or utilize the resource, and/or any other type of criterion required to access or utilize the resource, as described elsewhere herein.

To better understand the operation of credential management system 112 comprising credential validator 602 of system 600, FIG. 6 is further described with respect to FIG. 7. FIG. 7 shows a flowchart 700 of a process for skill-based authorization of resource access, in accordance with an example embodiment. In an embodiment, credential validator 602 of FIG. 6 operates according to one or more steps of flowchart 700. Note that not all steps of flowchart 700 need be performed in all embodiments. Further structural and operational embodiments will be apparent to persons skilled in the relevant art(s) based on the following descriptions of FIGS. 6 and 7.

Flowchart 700 begins with step 702. In step 702, an access request to a resource is received on behalf of the user account, the access request comprising the verifiable credential. For example, credential validator 602 of FIG. 6 receives an access request 606 for access to resource 604 on behalf of a user account. Access request 606 comprises a verifiable credential assigned to the user or otherwise requests verification that the user possesses the verifiable credential.

In step 704, the verifiable credential is validated. For example, credential validator 602 validates the verifiable credential. In an embodiment, credential validator 602 accesses skills attributions 144 to verify the verifiable credential. In an aspect, credential validator 602 determines if the verifiable credential matches the verifiable credential corresponding to skill 210 of skill attributions 144. In another embodiment, credential validator 602 verifies a signature of the provided verifiable credential.

In step 706, access to the resource is enabled responsive to validation of the verifiable credential. For example, responsive to determining the verifiable credential is valid, credential validator 602 provides a response 608 to application 156 indicating access to resource 604 is granted. In an embodiment, response 608 comprises an access token that application 156 can present to resource 604 or an access manager of resource 604 in order to access resource 604.

### IV. Example Task Determination Embodiments

As described herein, in some embodiments, skills are broken up into tasks. A learning plan can comprise separate modules for different tasks, a module that teaches a subset of the tasks, and/or the like. Embodiments operate in various ways for learning plan generation and assessment involving tasks. For instance, FIG. 8 shows a flowchart 800 for learning plan generation and assessment, in accordance with an example embodiment. In an embodiment, learning plan generation system 104 and assessment system 106 of FIG. 2 operate according to one or more steps of flowchart 800. Note that not all steps of flowchart 800 need be performed in all embodiments. Further structural and operational embodiments will be apparent to persons skilled in the relevant art(s) based on the following description of FIG. 8 with respect to FIG. 2.

Flowchart 800 begins with step 802. In step 802, a first task the first skill is used to perform is determined. For example, generative AI model 146 determines a task that skill 210 is used to perform. The task can represent a portion of operations skill 210 can be used for performing. In some embodiments, generative AI model 146 determines multiple tasks for a single skill.

In step 804, the first executable module is generated to assess if the user account satisfies a first task criterion indicative that the corresponding user is able to perform the task. For example, generative AI model 146 generates learning plan 226 comprising a module to assess if the user account satisfies a first task criterion indicative that the user corresponding to the user account is able to perform the task. In some embodiments, generative AI model 146 determines a separate module for different tasks of a plurality of tasks. In an embodiment, generative AI model 146 searches for and organizes existing content for teaching the task. In another embodiment, generative AI model 146 generates content for teaching the task. Examples regarding generating content are described further in Section VI. Sub-section E, as well as elsewhere herein.

As stated above, generative AI model 146 can search for and/or organize existing content for teaching the task. For example, generative AI model 146 searches for articles, videos, presentations, and/or other types of content related to the task. Generative AI model 146 can search the Internet, previously crawled content, a database, and/or other locations where content can be stored and/or maintained. Generative AI model 146 selects relevant content from the search results, e.g., based on semantic similarity to the task or skill, based on whether or not the content overlaps with other identified content, based on whether or not the content is in a suitable format for presenting to the user, and/or the like. Generative AI model 106 organizes the content in an order intended to teach the first task and/or its associated skill. For instance, generative AI model 106 in an implementation causes content related to the first task at a high level (e.g., broader information, information that defines terms used at the lower level, etc.) to be presented prior to content related to the first task at a lower level (e.g., specific details, higher technical details, certain use cases, etc.). By automatically organizing content in this manner, generative AI model 106 provides a logical flow by which content is presented to the user. Furthermore, generative AI model 106 can insert knowledge checks or other types of assessments in between content to determine whether or not the user satisfies a level of proficiency for proceeding further along the learning plan. As an example, if a user fails a knowledge check related to the high level overview of the task, the learning plan can cause the user to re-review the content related to the high level overview or present additional content related to the high level overview prior to allowing access to the lower level and/or specific content. By gating access to lower level material, the learning plan increases the likelihood that a user is able to understand lower level content.

In step 806, a determination of whether or not the user response satisfies a validation criterion specifying an assessment that the first task criterion is satisfied is made. For example, credential assessor 130 makes a determination of whether or not a response indicated by indication 234 satisfies task criterion of the first task.

### V. Example Embodiments of Skill Object Models

In some embodiments, skills are represented as skill object models. A skill object model describes a skill, its attributes, and its relationships with content, other skills, tasks, modules, and/or other objects in a system. Skill object models can be configured in various ways, in embodiments. For instance, FIG. 9 shows a block diagram of a skill object model 900, in accordance with an example embodiment. In an embodiment, skill object model 900 is a DAG. As shown in FIG. 9, skill object model 900 (also referred to as “SOM 900” herein) comprises a representation of skill 210 as described with respect to FIG. 2, as well as representations of content 902, content 904, content 906, a task 910, and a task 912. In an example, content 902-906 are examples of content 138-140 managed by content management system 110 of FIG. 1.

SOM 900 can be used to identify relationships between skill 210 and other objects of SOM 900. For instance, suppose generative AI model 146 of FIG. 2 receives prompt 222 specifying generative AI model 146 is to generate a learning plan for skill 210. Generative AI model 146 accesses SOM 900 and identifies content 902-906, each of which provide details regarding skill 201. Generative AI model 146 can generate a module or set of modules utilizing content of content 902-906. In another aspect, generative AI model 146 identifies tasks 910 and 912 as tasks of skill 210. In this example, generative AI model 146 divides skill 210 into tasks 910 and 912 and generates respective modules for teaching tasks 910 and 912.

Thus, an example of a SOM and how it is used for generating modules has been described with respect to SOM 900 of FIG. 9. In some cases, a generative AI model can utilize a SOM to identify dependencies between multiple skills. Such SOMs can be configured in various ways. For instance, FIG. 10 shows a block diagram of a skill object model 1000 (“SOM 1000” herein), in accordance with another example embodiment. As shown in FIG. 10, SOM 1000 comprises object representations of skill 210 and tasks 910 and 912, as described with respect to FIG. 9, as well as object representations of a skill 1002, a skill 1004, a task 1006, a task 1008, a task 1010, and a task 1012. As shown in FIG. 10, skill 1002 is dependent on skill 210 and includes tasks 1006 and 1008 and skill 1004 is dependent on task 910 and includes tasks 1010 and 1012.

Generative AI model 146 can utilize SOM 1000 to determine relationships between multiple skills. These relationships can be used to identify additional content, learning opportunities, and/or learning requirements. For instance, in an aspect where multiple skills are required to satisfy target goal criteria, a learning plan generating system can determine a sequential order the skills should be learned in. In this context, generative AI model 146 can utilize skill object models such as skill object model 1000 to determine relationships between skills, such as dependencies of one skill on another. For instance, suppose skill 1002 is an advanced skill that requires proficiency in skill 210 as a foundation. In this context, generative AI model 146 generates learning plan 226 comprising a first module to teach skill 210 and a second module to teach skill 1002 with instructions to restrict access to the second module until successful completion of the first module.

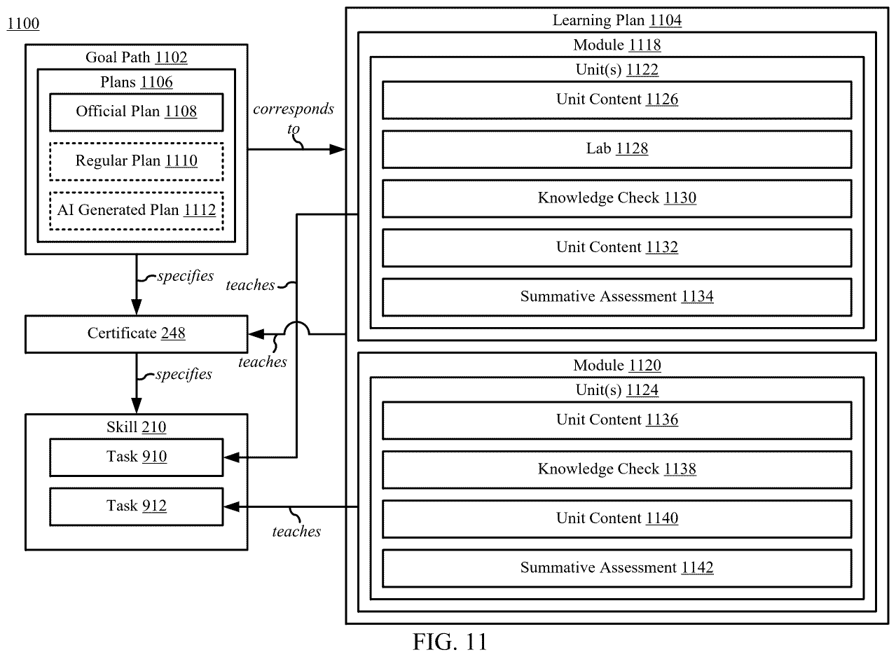

In some embodiments of skill object models, a skill object model can represent a wide variety of related objects in a system, such as goals, certificates, and learning plans. These types of skill object models can be configured in various ways, in embodiments. For instance, FIG. 11 shows a block diagram of a skill object model 1100, in accordance with an example embodiment. As shown in FIG. 11, skill object model 1100 (“SOM 1100” herein) comprises representations of certificate 248 and skill 210 (comprising task 910 and task 912 of FIG. 9) as described with respect to FIG. 2, as well as representations of a goal path 1102 and a learning plan 1104. Learning plan 1104 comprises modules 1118 and 1120, which are further examples of executable modules generated by learning plan generator 124, as described herein. SOM 1100 further includes relationship information between different objects. For instance, SOM 1100 shows that goal path 1102 corresponds to learning plan 1104 and specifies (e.g., requires for satisfying goal criteria) certificate 248, shows that certificate 248 specifies (e.g., requires for satisfying certification criteria) skill 210 and is taught by learning plan 1104 (e.g., skills for satisfying certification criteria are taught by learning plan 1104), shows that task 910 of skill 210 is taught by module 1118 and shows that task 912 of skill 210 is taught by module 1120.

Goal path 1102 is an object representative of a target goal. Goal path 1102 specifies information related to the target goal such as, but not limited to, certifications required to fulfill the goal, skills required to fulfill the goal, content related to the goal, privileges granted by the goal, tasks that can be performed with the goal, and/or any other information related to the target goal. As shown in FIG. 11, goal path 1102 comprises one or more plans 1106 (“plans 1106” herein). Plans 1106 are plans for satisfying the target goal of goal path 1102. Plans can specify skills and/or other requirements to fulfill the target goal, tasks to perform to fulfill the target goal, a recommended order in learning skills and/or fulfilling other requirements, and/or any other information related to fulfilling goal criteria of the target goal. For instance, in an embodiment, plans 1106 specify certificate 248 is required to satisfy the target goal. As shown in FIG. 11, plans 1106 comprise an official plan 1108 and, optionally, a regular plan 1110 and/or an AI generated plan 1112. Official plan 1108 represents a plan for fulfilling the target goal of goal path 1102. In an embodiment, official plan 1108 is automatically generated (e.g., utilizing a generative AI model or other automatic content generation techniques), semi-automatically generated (e.g., with the assistance of a generative AI model or other automatic content generation techniques), or manually generated (e.g., by a goal manager, a learning content developer, and/or another type of user that generates plans for satisfying target goal criteria). In an aspect shown in FIG. 11, official plan 1108 specifies certificate 248 is required for satisfying the target goal. For instance, suppose the target goal is a role position a user intends to apply for. In this example, official plan 1108 specifies the role position requires candidates to possess certificate 248. Regular plan 1110 represents another type of plan for satisfying target goal criteria. In an embodiment, regular plan 1110 is generated semi-automatically or manual. Regular plan 1110 can represent an alternative plan to official plan 1108 or a development-in-progress plan. AI generated plan 1112 represents another type of plan for satisfying target goal criteria. In an embodiment, AI generated plan 1112 is generated automatically utilizing a generative AI model. AI generated plan 1112 can represent an alternative plan to official plan 1108 or a development-in-progress plan.

Learning plan 1104 is an object representative of a learning plan generated by learning plan generator 124 (e.g., utilizing generative AI model 146). For instance, in an embodiment, generative AI model 146 generates learning plan 1104 utilizing goal path 1102, certificate 248, and/or skill 210 objects, respective relationships, and/or sub-objects thereof and learning plan generator 124 updates SOM 1100 to include the object representative of learning plan 1104 and its relationships to the goal path 1102, certificate 248, and/or skill 210 objects. As described herein, learning plan 1104 comprises modules 1118 and 1120. In an embodiment, learning plan 1104 specifies an order in which modules 1118 and 1120 are to be performed.

Modules 1118 and 1120 are objects representative of their respective executable modules. As shown in FIG. 11, module 1118 teaches task 910 and module 1120 teaches task 912. Modules 1118 and 1120 comprise a one or more respective units. A unit is a granular piece of material associated with a respective module. Examples of a unit include, but are not limited to, content of a module, a combination of multiple pieces of content (e.g., text generated from one or more articles, worksheets, and/or books), a lab or other exercise, a knowledge check, a summative assessment, an introduction to a module that describes an overview of concepts taught by the module, a summary of concepts taught by the module, and/or any other material associated with a module. Units within a module are related to each other. For instance, in a non-limiting example, a first unit of a module provides an overview of concepts taught by the module, a second unit of the module discusses the concepts, a third unit of the module performs a knowledge check based on the material discussed in the second unit, a fourth unit of the module discusses further concepts, a fifth unit performs a knowledge check based on the material discussed in the fourth unit, a sixth unit performs a summative assessment of all of the concepts covered by the module, and a seventh unit provides a summary of the concepts covered by the module.

Modules can include any number of units. For instance, as shown in FIG. 11, module 1118 comprises one or more units 1122 (“units 1122” herein) and module 1120 comprises one or more units 1124 (“units 1224” herein). In some embodiments, the order in which units of units 1122 and/or units 1124 within a respective module are to be performed is specified and/or enforced. As shown in FIG. 11, units 1122 comprise five units, unit content 1126, a lab 1128, a knowledge check 1130, unit content 1132 and a summative assessment 1134, and units 1124 comprise four units, unit content 1136, a knowledge check 1138, unit content 1140, and a summative assessment 1142.

Unit content 1126, unit content 1132, unit content 1136, and unit content 1140 represent content presented in a user interface as part of execution of a respective module. Such content can include, but not is not limited to, content determined to be relevant to the unit (e.g., by generative AI model 146 in generation of the unit), artificially generated or aggregated content (e.g., a summary or alternatively presented version of content semantically similar to the concept of the unit), and/or other content suitable for teaching a concept of the unit. Lab 1128 represents exercises, experiments, practice tests, and/or other performable activities or operations for practicing or demonstrating tasks or sub-tasks related to the concept of module 1118. In an embodiment where lab 1128 is performed after unit content 1126, lab 1128 is an exercise intended to reinforce concepts described by unit content 1126. For instance, suppose in a non-limiting example that unit content 1126 described techniques for programming features in a software development program. In this example, lab 1128 comprises an exercise instructing a user to write code related to the described techniques. Knowledge checks 1130 and 1138 represent questionnaires, tests, exams, and/or other assessment techniques for measuring or testing a proficiency in the concept of the unit. In an aspect, knowledge check 1130 and/or 1138 assess a proficiency in a concept of a previous unit. For instance, in the non-limiting example described with respect to lab 1128, knowledge check 1130 is a questionnaire related to the techniques described in unit content 1126 and the code written in lab 1128. Summative assessments 1134 and 1142 represent measures of whether or not a user has demonstrated proficiency in the concept of the module. In an embodiment, a summative assessment object specifies rules and/or criteria that need to be satisfied in order to determine a user has demonstrated proficiency in the concept. For instance, a summative assessment object can specify a percentage of questions that are to be answered correctly in order to pass the respective module. In an embodiment, learning plan 1104 comprises a separate summative assessment object (not shown in FIG. 11 for brevity) that represent a measure of whether or not a user has demonstrated proficiency in concepts taught by both modules 1118 and 1120.

In an embodiment, skill object model 1100 includes mappings (not shown in FIG. 11 for brevity) of relationships between units. For instance, in an example, skill object model 1100 illustrates a relationship between unit content 1126 and lab 1128 indicating lab 1128 is a practical exercise related to concepts taught by unit content 1126, a relationship between unit content 1126 and knowledge check 1130 indicating knowledge check 1130 is an assessment of concepts taught by unit content 1126, and a relationship between summative assessment 1134 and unit content 1126 and 1132 indicating summative assessment 1134 is an assessment of concepts taught by both unit content 1126 and 1132. In a further example, skill object model 1100 illustrates relationships between units showing an order in which different content is provided. For instance, skill object model 1100 can include a relationship between unit content 1126 and unit content 1132 indicating that unit content 1126 is taught prior to unit content 1132 and/or that unit content 1132 builds upon a concept taught by unit content 1126. In another embodiment, skill object model 1100 specifies whether or not units can be performed out of order. For instance, suppose in another non-limiting example, unit content 1136 and unit content 1140 can be performed in any order as they teach different concepts of module 1120. In this context, skill object model 1100 can include mappings that indicate summative assessment 1142 is an assessment of concepts taught by unit content 1136 and 1140 and that unit content 1136 and 1140 can be performed in either order.

In some embodiments, completion of some units and not others can be utilized in reassessing/recreating learning plans for teaching a skill or task to a user. For instance, if a user is able to complete unit content 1126, lab 1128, and knowledge check 1130 but not unit content 1132 and an associated knowledge check unit (not shown in FIG. 11 for brevity), learning plan generator 124 can generate a new learning plan that focuses on teaching and assessing concepts related to unit content 1132 more than concepts related to unit content 1126. Furthermore, suppose the types of unit content 1126, lab 1128, and/or knowledge check 1130 differ from the types of unit content 1132 and/or the knowledge check associated with unit content 1132. In this context, generative AI model 146 can evaluate whether or not the types of unit content 1126, lab 1128, and/or knowledge check 1130 have a higher efficacy in teaching a concept to the user than the types of unit content 1132 and/or the associated knowledge check and, if so, generate a new set of units covering the concepts of unit content 1132 utilizing techniques of unit content 1126, lab 1128, and/or knowledge check 1130. For instance, suppose generative AI model 146 determines a user learns more effectively from hands-on activities or problem solving tests than a lecture. Further suppose unit content 1132 utilized primarily written articles or video lectures for providing material for learning its concept(s). In this example, generative AI model 146 generates a new set of units directed to the concepts of unit content 1132 but utilizing an increased number of problem-solving activities, hands-on experiments, and other interactive tools within the unit content, labs, and knowledge checks in order to increase a likelihood the user succeeds in demonstrating a proficiency in the concept of the unit. By updating/modifying units in this manner, generative AI model 146 is able to improve the user experience of learning plan 1104. Furthermore, a user account can be tagged with a tag indicating an automatically determined preferred learning style of the user, thereby reducing the compute resources expended learning plan generation systems and/or generative AI models in generating future learning plans for the user account.

### VI. Further Skill-Based Embodiments

### A. Event-Based Automatic Learning Plan Generation Embodiments

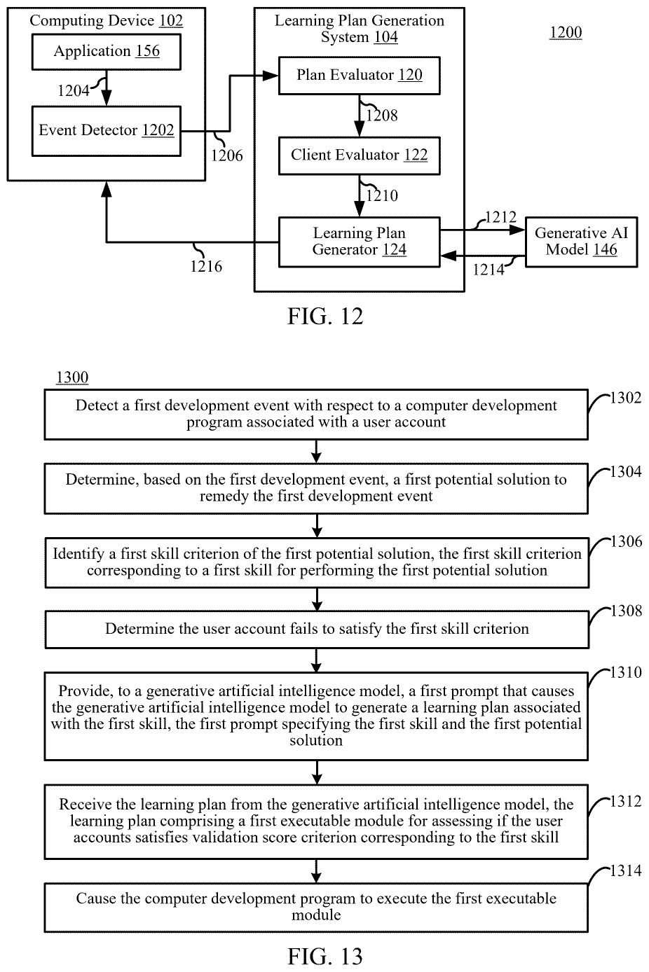

Embodiments of learning plan generation systems can be implemented in a variety of skill-based applications. For instance, learning plan generation system 104 can be implemented in a system for providing automatic learning plan generation based on events. A system that generates learning plans based on events can be configured in various ways, in embodiments. For example, FIG. 12 shows a block diagram of a system 1200 for automatic skill assessment and learning plan generation, in accordance with an example embodiment. As shown in FIG. 12, system 1200 comprises computing device 102 (executing application 156), learning plan generation system 104 (comprising plan evaluator 120, client evaluator 122, and learning plan generator 124), and generative AI model 146, as described with respect to FIG. 1. As further shown in FIG. 12, computing device 102 also executes an event detector 1202. Event detector 1202 is configured to detect events with respect to application 156 and/or computing device 102. As shown in FIG. 12, event detector 1202 is service executing on computing device 102 that monitors activity of application 156 (and optionally other applications or components of computing device 102) via monitoring signal 1204 for events. Alternatively, event detector 1202 is a subcomponent and/or subservice of learning plan generation system 104 and monitors signals and/or information generated by computing device 102. In another embodiment, event detector 1202 is external to computing device 102 and learning plan generation system 104, e.g., as a service executing by a separate server. Event detector 1202 can passively detect events by monitoring operations, analyzing information, and automatically detecting the event based on a result of the analysis. Alternatively, event detector 1202 receives a request corresponding to an event from application 156. The request can be automatically generated by application 156 (e.g., application 156 encountering or flagging an error) or responsive to user interaction (e.g., user interaction with a widget presented in a user interface of application 156).

As described herein, event detector 1202 is configured to detect triggering events. Example triggering events include, but are not limited to development events, security events, learning events, browsing events, and/or other events caused by operation of computing device 102 and/or services executed thereon. A development event is an event related to development of a computing program, a security event is an event related to secure operation of a device or service, a learning event is an event related to tutoring and learning material, and a browsing event is an event related to browsing the web. Example development events include, but are not limited to, executing code, writing code, executing a debugging module with respect to code, occurrence of compilation errors, occurrence of logic errors, occurrence of semantic errors, occurrence of runtime errors, a query regarding a function or operation, a query regarding a library, and/or other events related to the development of computer programs. Example security events include, but are not limited to, an alert from a firewall, an attempt to access an unauthorized resource, an attempt to access an unauthorized website or account, detection of a security vulnerability, and/or other events related to secure operation of a device or service. Example learning events include, but are not limited to, browsing web page related to a course or certification, executing an executable module, requesting additional information or skill testing, and/or other events related to learning or assessing proficiency in skills. Example browsing events include, but are not limited to, browsing to a skill-based access-restricted website, browsing to a role-based access-restricted website, searching for a tutorial on how to perform a task, searching for documents regarding certification requirements, job requirements, or role requirements, and/or other events related to browsing.

Learning plan generation system 104 can assess a proficiency of a user in a skill or task and generate learning plans based on events detected by event detector 1202. For instance, in an embodiment, event detector 1202 is a code development event detector and application 156 is a code development program. In this context, event detector 1202 detects development events with respect to application 156 and causes learning plan generation system 104 to generate a learning plan based on the detected development event. Event detector 1202 and learning plan generation system 104 operate in this context in various ways. For instance, FIG. 13 shows a flowchart 1300 of a process for automatic skill assessment and learning plan generation, in accordance with an example embodiment. In an embodiment, event detector 1202 and learning plan generation system 104 of FIG. 12 operate according to one or more steps of flowchart 1300. Note that not all steps of flowchart 1300 need be performed in all embodiments. Further structural and operational embodiments will be apparent to persons skilled in the relevant art(s) based on the following description of FIG. 13 with respect to FIG. 12.

Flowchart 1300 begins with step 1302. In step 1302, a first development event is detected with respect to a computer development program associated with a user account. For example, event detector 1202 monitors application 156 via a monitoring signal 1204 and detects an event 1206 with respect to application 156. In this example, application 156 is a computer development program that is utilized in developing computer programs and event 1206 is a development event. As shown in FIG. 12, event detector 1202 provides event 1206 to plan evaluator 120 for evaluation thereof.

In step 1304, a first potential solution to remedy the first development event is determined based on the first development event. For example, plan evaluator 120 determines a first potential solution based on event 1206. Plan evaluator 120 can determine the potential solution utilizing generative AI model 146 or a generative AI model trained to determine potential solutions. Alternatively, plan evaluator 120 determines the potential solution by matching keywords of the detected event to pre-generated potential solutions or stored solutions to previous development events. In another alternative, plan evaluator 120 determines the potential solution by determining a semantic similarity between the detected event and a pre-generated or stored solution satisfies a criterion.

In step 1306, first skill criterion of the first potential solution is identified, the first skill criterion corresponding to a first skill for performing the first potential solution. For example, plan evaluator 120 identifies a skill criterion of the potential solution, the skill criterion corresponding to a skill for performing the potential solution. Plan evaluator 120 can determine the skill criterion based on tags of the potential solution, semantic similarities between the potential solution and operations performed utilizing the task satisfying a criterion, a tool utilized to perform the potential solution, and/or other information suitable for determining skills required to perform a solution. As shown in FIG. 12, plan evaluator 120 provides plan information 1208 to client evaluator 122, where plan information 1208 specifies the potential solution, event 1206, and the skill criterion of the potential solution.

In step 1308, the user account is determined to fail to satisfy the first skill criterion. For example, client evaluator 122 determines the user account associated with application 156 and/or computing device 102 fails to satisfy the skill criterion of the potential solution based on plan information 1208. Client evaluator 122 determines this failure in a similar manner as described with respect to step 304 of FIG. 3, as well as elsewhere herein. As shown in FIG. 12, client evaluator 122 provides a client evaluation result 1210 to learning plan generator 124 that specifies a result of its determination.

In step 1310, a first prompt is provided to a generative AI model, the first prompt causing the generative AI model to generate a learning plan associated with the first skill and specifying the first skill and the first potential solution. For example, learning plan generator 124 provides a prompt 1212 to generative AI model 146. Prompt 1212 includes instructions that cause generative AI model 146 to generate a learning plan 1216 associated with the skill the user account does not possess attribution for and the potential solution determined by plan evaluator 120. Prompt 1212 is generated in a similar manner as prompt 222 of FIG. 2.

In step 1312, the learning plan is received from the generative AI model, the learning plan comprising a first executable module for assessing if the user account satisfies validation score criterion corresponding to the first skill. For example, learning plan generator 124 receives learning plan 1216 from generative AI model in a response 1214. Learning plan 1216 includes a first executable module for assessing if the user account satisfies validation score criterion corresponding to the skill.

In step 1314, the computer development program is caused to execute the first executable module. For example, learning plan generator 124 causes application 156 or another application of computing device 102 to execute executable modules of learning plan 1216.

### B. Automatic Skill Assignment Embodiments

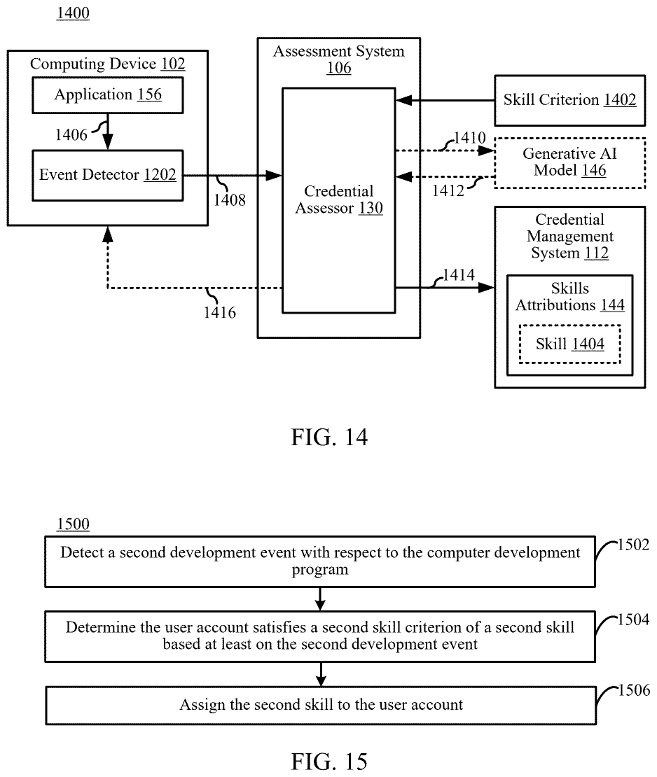

Embodiments of assessment systems can be implemented in a variety of skill-based applications. For instance, assessment system 106 can be implemented in a system for providing automatic skill assignment based on events. A system that utilizes event-based skill assignment can be configured in various ways, in embodiments. For example, FIG. 14 shows a block diagram of a system 1400 for automatic skill assessment and assignment, in accordance with an example embodiment. As shown in FIG. 14, system 1400 includes computing device 102 (executing application 156 and event detector 1202 as described with respect to FIG. 12), assessment system 106 (comprising credential assessor 130), credential management system 112 (managing skill attributions 144), and, optionally, generative AI model 146, as described with respect to FIG. 1, as well as skill criterion 1402. Skill criterion 1402 specifies criterion for demonstrating proficiency in a skill 1404.

To better understand the operation of event detector 1202 and credential assessor 130 in automatic skill assessment and assignment, FIG. 14 is described with respect to FIG. 15. FIG. 15 shows a flowchart 1500 of a process for automatic skill assessment and assignment, in accordance with an example embodiment. In an embodiment, event detector 1202 and credential assessor 130 of FIG. 14 operate according to one or more steps of flowchart 1400. Note that not all steps of flowchart 1500 need be performed in all embodiments. Further structural and operational embodiments will be apparent to persons skilled in the relevant art(s) based on the following description of FIG. 15 with respect to FIG. 14.

Flowchart 1500 begins with step 1502. In step 1502, a second development event is detected with respect to the computer development program. For example, event detector 1202 monitors application 156 via monitoring signal 1406 and detects event 1408. Event detector 1202 monitors and detects events in a similar manner as described with respect to step 1302 of flowchart 1300 of FIG. 2, as well as elsewhere herein.

In step 1504, the user account is determined to satisfy a second skill criterion of a second skill based at least on the second development event. For example, credential assessor 130 determines the user account satisfies a skill criterion 1402 of skill 1404 based at least on event 1408. In this context, credential assessor 130 determines that event 1408 demonstrates the user is proficient in a skill. In some embodiments, credential assessor 130 utilizes generative AI model 146 in determining skill criterion 1402 to determine if event 1408 is indicative of a proficiency in a skill. For instance, generative AI model 146 is prompted with a prompt 1410 specifying instructions to identify skills related to event 1408 and generate a learning plan for the skills. The instructions further specify generative AI model 146 is to generate a practical assessment of the skill based on event 1408. In this manner, prompt 1410 causes generative AI model 146 to determine if there are any skills related to event 1408 that the user account is not attributed with and, if there is a skill, determine a learning plan for the skill that is satisfied by event 1408. If generative AI model 146 is able to generate a valid learning plan in this manner, flowchart 1500 continues to step 1506.

In step 1506, the second skill is assigned to the user account. For example, credential assessor 130 provides an assignment signal 1414 to credential management system 112 causing skill 1404 to be assigned to the user account. Assignment signal 1414 causes skill 1404 to be assigned to the user account in a similar manner as described with respect to step 406 of flowchart 400 of FIG. 4 and/or step 506 of flowchart 500 of FIG. 5, as well as elsewhere herein.

### C. Skill-Based Event Mitigation Embodiments

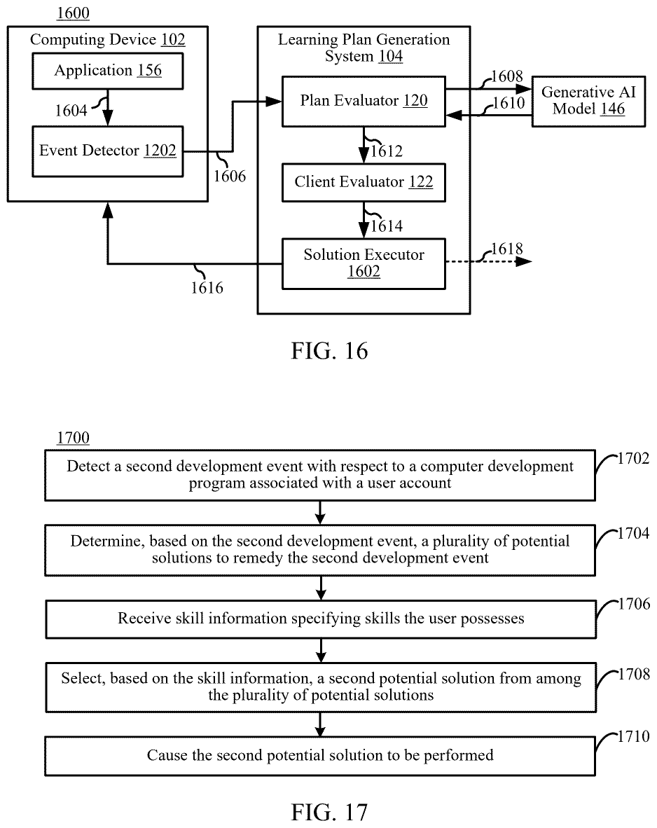

As described elsewhere herein, embodiments of learning plan generation systems can be implemented in a variety of skill-based applications. For instance, learning plan generation system 104 can be implemented in a system for providing skill-based event mitigation. A system that utilizes learning plan generation system 104 for skill-based event mitigation can be configured in various ways, in embodiments. For example, FIG. 16 shows a block diagram of a system 1600 for automatic skill-based event mitigation, in accordance with an example embodiment. As shown in FIG. 16, system 1600 includes computing device 102 (executing application 156 and event detector 1202 as described with respect to FIG. 12), learning plan generation system 104 (comprising plan evaluator 120 and client evaluator 122), and generative AI model 146, as described with respect to FIG. 1. As also shown in FIG. 16, learning plan generation system 104 also includes a solution executor 1602, which is a computer-implemented sub-service of learning plan generation system 104. Solution executor 1602 comprises logic for executing solutions for mitigating events.

To better understand the operation of learning plan generation system 104 comprising solution executor 1602, FIG. 16 is described with respect to FIG. 17. FIG. 17 shows a flowchart 1700 of a process for automatic skill-based event mitigation, in accordance with an example embodiment. In an embodiment, event detector 1202 and learning plan generation system 104 of FIG. 16 operate according to one or more steps of flowchart 1700. Note that not all steps of flowchart 1700 need be performed in all embodiments. Further structural and operational embodiments will be apparent to persons skilled in the relevant art(s) based on the following description of FIG. 17 with respect to FIG. 16.

Flowchart 1700 begins with step 1702. In step 1702, a second development event is detected with respect to a computer development program associated with a user account. For example, event detector 1202 monitors application 156 via a monitoring signal 1604 and detects an event 1606. Event detector 1202 detects event 1606 in a similar manner as described with respect to step 1302 of flowchart 1300 of FIG. 13, as well as elsewhere herein.

In step 1704, a plurality of potential solutions to remedy the second development event is determined based on the second development event. For example, plan evaluator 120 determines a plurality of potential solutions 1610 to remedy event 1606 based on event 1606. In an aspect, and as shown in FIG. 16, plan evaluator 120 utilizes generative AI model 146 to determine plurality of potential solutions 1610. For instance, plan evaluator 120 provides a prompt 1608 specifying instructions to determine solutions for mitigating event 1606. In embodiments, generative AI model 146 determines the solutions based on respective levels of semantic similarity to event 1606 satisfying a criterion, e.g., by accessing previously performed solutions and determining their respective levels of similarities. As shown in FIG. 16, plan information 1612 is provided to client evaluator 122, where plan information comprises the plurality of potential solutions 1612.

In step 1706, skill information specifying skills the user possesses is received. For example, client evaluator 122 receives skill information specifying one or more skills of the user. For instance, in an embodiment, the skill information specifies skills attributed to the user account of the user. Client evaluator 122 can receive skill information in a similar manner as it received profile data 150, as described with respect to FIG. 2.

In step 1708, a second potential solution is selected from among the plurality of potential solutions based on the skill information. For example, client evaluator 122 selects a potential solution 1614 from among potential solutions 1610 based on skill information received in step 1706. In this manner, client evaluator 122 determines which potential solutions a user is able to perform based on their attributed skills and selects a potential solution based on their attributed skills.

In step 1710, the potential solution is caused to be performed. For example, solution executor 1602 receives potential solution 1614 and causes execution thereof by providing instructions 1616 to computing device 102. Instructions 1616 cause computing device 102 or an application executing thereon to perform potential solution 1614. In some embodiments, solution executor 1602 performs some or all steps of potential solution 1614. For instance, in an embodiment, solution executor performs an automated solution action 1618 to perform some or all steps of potential solution 1614.

### D. Skill-Based Model Training Embodiments

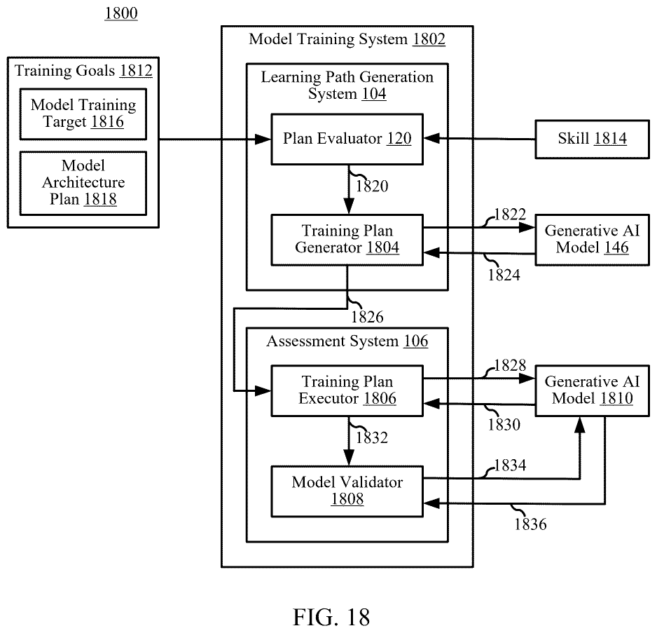

Embodiments of learning plan generation systems and assessment systems can be implemented in a variety of skill-based applications. For instance, learning plan generation system 104 and assessment system 106 can be implemented in a system for training machine learning models, such as generative AI models. A system that utilizes learning plan generation and assessment for training a model can be configured in various ways, in embodiments. For example, FIG. 18 shows a block diagram of a system 1800 for skill-based model training, in accordance with an example embodiment. As shown in FIG. 18, system 1800 comprises generative AI model 146, as described with respect to FIG. 1, as well as a model training system 1802 and a generative AI model 1810. Model training system 1802 is a computer-implemented system for training generative AI models, such as generative AI model 1810. As also shown in FIG. 18, model training system 1802 includes learning plan generation system 104 (including plan evaluator 120) and assessment system 106, as described with respect to FIG. 1. Learning plan generation system 104 further includes a training plan generator 1804, which operates in a similar manner as learning plan generator 124. For instance, training plan generator 1804 comprises logic for generating training plans for use in training generative AI models. Assessment system 106 comprises a training plan executor 1806 and a model validator 1808, each of which are implemented as subservices and/or subcomponents of assessment system 106. Training plan executor 1806 operates similar to module executor 126 of FIG. 1 and comprises logic for executing a training plan to train a generative AI model. Model validator 1808 operates similar to progress evaluator 128 and/or credential assessor 130 of FIG. 1 and comprises logic for validating a generative AI model trained by training plan executor 1806.

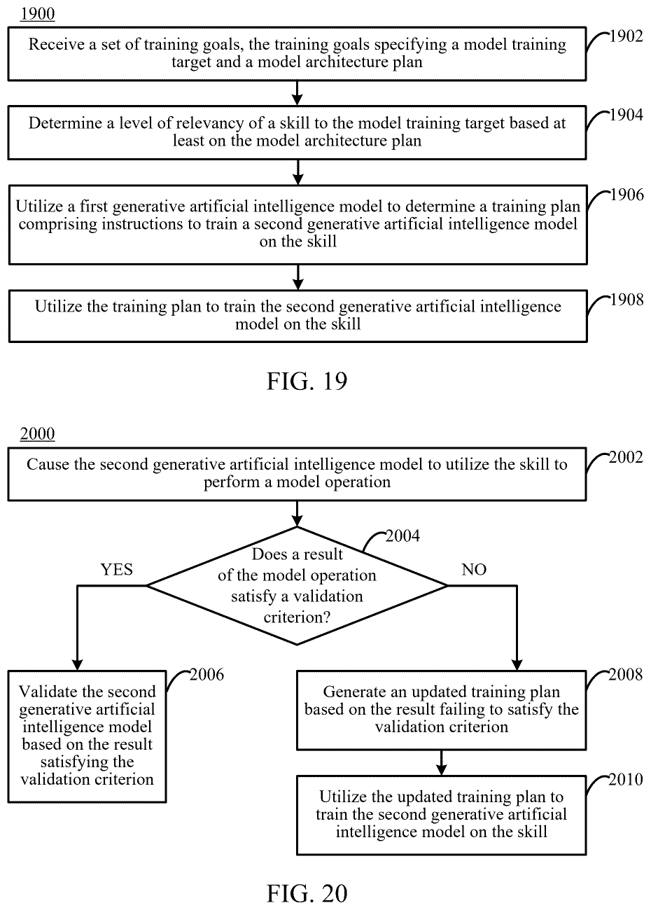

To better understand the operation of model training system 1802, FIG. 18 is described with respect to FIG. 19. FIG. 19 shows a flowchart 1900 of a process for skill-based model training, in accordance with an example embodiment. In an embodiment, model training system 1802 of FIG. 18 operates according to one or more steps of flowchart 1900. Note that not all steps of flowchart 1900 need be performed in all embodiments. Further structural and operational embodiments will be apparent to persons skilled in the relevant art(s) based on the following description of FIG. 19 with respect to FIG. 18.

Flowchart 1900 begins with step 1902. In step 1902, a set of training goals is received, the training goals specifying a model training target and a model architecture plan. For example, plan evaluator 120 of FIG. 18 receives training goals 1812 including a model training target 1816 and a model architecture plan 1818. Model training target 1816 specifies criteria for validating whether or not a model is successfully performing its trained duty, e.g., is a model configured to schedule system maintenance to reduce impact on workload generating schedules with a level of impact on a workload that satisfies a criterion. Model architecture plan 1818 specifies logical architecture of the model to be trained. In an aspect, model architecture plan 1818 represents a cloud architecture framework the model is to be trained on.

In step 1904, a level of relevancy of a skill to the model training target is determined based at least on the model architecture plan. For example, plan evaluator 120 of FIG. 18 determines one or more skills that have a level of relevancy to model training target 1816 that satisfies a criterion based at least on the model architecture plan and/or other information related to training goals 1812. In an embodiment, plan evaluator 120 utilizes embeddings to determine the level of relevancy. As an example described with respect to FIG. 18, suppose skill 1814 has a level of relevancy to training goals 1812 that satisfies relevant skill criterion. As shown in FIG. 18, plan evaluator 120 provides plan information 1820 to training plan generator 1804, wherein plan information 1820 specifies any skills that satisfy the relevant skill criterion, e.g., skill 1814, as well as any other information related to training models.

In step 1906, a first generative AI model is utilized to determine a training plan comprising instructions to train a second generative AI model on the skill. For example, training plan generator 1804 of FIG. 18 utilizes generative AI model 146 to determine a training plan 1826 by generating a prompt 1822 based on plan information 1820, wherein prompt 1822 specifies generative AI model 146 is to generate for training another model based on model training target 816, model architecture plan 1818, and the skill generative AI model 146 is to be trained to perform.

In step 1908, the training plan is utilized to train the second generative AI model on the skill. For example, training plan generator 1804 of FIG. 18 causes training plan executor 1806 to train generative AI model 1810 to utilize skill 1814. In an example, training plan 1826 causes generative AI model 1810 to generate output to be analyzed for determining if generative AI model 1810 is generating expected output. Training plan executor 1806 provides model input 1828 to generative AI model 1810 to adjust variables of the model or perform a training operation. Training plan executor 1806 receives output 1830 representative of a result of providing model input 1828. In an embodiment, training plan executor 1806 repeats providing input or making adjustments to generative AI model 1810 and receiving output.

In embodiments, assessment system 106 of FIG. 18 validates generative AI model 1810. Assessment system 106 is configured to assess the model in various ways. For example, FIG. 20 shows a flowchart 2000 of a process for skill-based model validation, in accordance with an example embodiment. In an embodiment, model training system 1802 of FIG. 18 operates according to one or more steps of flowchart 2000. Note that not all steps of flowchart 2000 need be performed in all embodiments. Further structural and operational embodiments will be apparent to persons skilled in the relevant art(s) based on the following description of FIG. 20 with respect to FIG. 18.

Flowchart 2000 begins with step 2002. In step 2002, the second generative AI model is caused to utilize the skill to perform a model operation. For example, training plan executor 1806 of FIG. 18 provides a training complete signal 1832 to model validator 1808 indicating generative AI model 1810 is ready for validation. Model validator 1808 causes generative AI model 1810 to utilize skill 1814 to perform a model operation 1834. In an embodiment, model operation 1834 specifies skill 1814 is to be used to perform the operation and/or other parameters of the operation.

In step 2004, a determination of whether or not a result of the model operation satisfies a validation criterion is made. For example, model validator 1808 of FIG. 18 receives a modeling result 1836 representative of an output generated by generative AI model 1810 performing operation 1834. If the result of the model operation satisfies the validation criterion, flowchart 2000 continues to step 2006. Otherwise, flowchart 2000 continues to step 2008.

In step 2006, the second generative AI model is validated based on the result satisfying the validation criterion. For example, model validator 1808 of FIG. 18 determines result 1836 satisfies validation criterion of training goals 1812.

In step 2008, an updated training plan is generated based on the result failing to satisfy the validation criterion. For example, model validator 1808 of FIG. 18 causes training plan generator 1804 to generate an updated version of training plan 1826. In an example, training plan generator 1804 generates a new prompt specifying a degree at which result 1836 differed from an expected result in performing operation 1834.

In step 2010, the updated training plan is utilized to train the second generative AI model on the skill. For example, training plan executor 1806 of FIG. 18 receives the updated version of training plan 1826 and trains generative AI model 1810 with the updated version in a similar manner as described with respect to step 1908.

### E. Content Generation Embodiments

Embodiments of learning plan generation systems have been described with respect to searching for and/or organizing content to be presented to a user and/or in a user interface. In some embodiments, learning plan generation systems generate content. Content can be generated from existing content and/or by applying other techniques to existing content. For instance, in an aspect, learning plan generator 124 of FIG. 1 generates new content by determining a framework of a skill to be taught to a user. The framework can specify related skills, tasks associated with the skill, and/or other information related to the skill. Learning plan generator 124 further determines assessment criteria for the skill. In this context, the assessment criteria specifies knowledge or other proficiencies a user is to demonstrate in order to be assigned the skill. In an aspect, learning plan generator 124 determines the assessment criteria based on certification requirements associated with the skill, manual indications determined by an authority entity, and/or by utilizing generative AI model 146. For instance, as a non-limiting example, learning plan generator 124 utilizes generative AI model 146 to generate assessment criteria based on previous assessments related to the skill, teacher guides related to the skill, operations performed using the skill, and/or other information related to the skill.

In embodiments of content generation, learning plan generator 124 generates content designed and/or organized with the assessment criteria in mind. In this context, the generated content is designed in a manner to efficiently teach concepts related to the skill, thereby reducing the amount of excess information (also referred to as “bloat”) presented in a user interface. In an example, learning plan generator 124 utilizes generative AI model 146 to generate content based on existing content. For instance, in an embodiment, prompt 222 of FIG. 2 causes generative AI model 146 to determine content related to the skill and assessment criteria (e.g., based on semantic similarity, based on matching keywords, based on tags, and/or the like) and generate new content from the determined related content. In an aspect, generative AI model 146 generates the new content by organizing and presenting excerpts of the related content in a unified matter. For instance, generative AI model 146 can collect text, graphics, videos, and/or other content, determine portions of the collected content that is relevant to the assessment criteria, and generate a summative article, presentation, video, or other content that focuses on the relevant portions. By generating new content in this manner, generative AI model 146 provides learning content that is focused on the concepts of a skill required to successfully satisfy assessment criteria. This can improve the likelihood of passing a knowledge check, summative assessment, or other type of assessment related to the skill. Furthermore, generating the focused content reduces the amount of content to be presented in a user interface, thereby reducing compute resources utilized in presenting content.

As described herein, learning plan generator 124 can cause generative AI model 146 to generate new content that focuses on assessment criteria. In this context, generative AI model 146 can further be utilized to organize or otherwise present the content in a medium based on the user and/or concept to be taught. For instance, suppose generative AI model 146 determines a user learns better from graphic and/or video content than purely text-based content. In this example, generative AI model 146 generates graphic presentations, graphics with accompanying audio content, and/or videos from relevant content. By automatically determining a preferred medium to present content in and automatically generating content in the preferred medium, such embodiments of learning plan generator 124 utilizing generative AI model 146 can improve the likelihood a user is able to successfully pass assessments associated with the skill. By improving the likelihood a user is able to successfully pass assessments, these embodiments reduce the expenditure of compute resources in re-executing modules and/or having to generate new learning plans for the same skill.

### VII. Example Computer System Implementation

Systems, devices, components, and/or techniques described herein are implemented in hardware, or hardware combined with one or both of software and/or firmware. For example, plan evaluator 120, client evaluator 122, learning plan generator 124, module executor 126, progress evaluator 128, credential assessor 130, plan generator 132, generative AI model 146, application 156, API gateway 158, credential validator 602, resource 604, skill object model 900, skill object model 1100, skill object model 1100, event detector 1202, solution executor 1602, training plan generator 1804, training plan executor 1806, model validator 1808, generative AI model 1810, and/or each of the components described therein, and/or the steps of flowcharts 300, 400, 500, 700, 800, 1300, 1500, 1700, 1900, and/or 2000 are each implemented as computer program code/instructions configured to be executed in one or more processors and stored in a computer readable storage medium. Alternatively, plan evaluator 120, client evaluator 122, learning plan generator 124, module executor 126, progress evaluator 128, credential assessor 130, plan generator 132, generative AI model 146, credential validator 602, resource 604, event detector 1202, solution executor 1602, training plan generator 1804, training plan executor 1806, model validator 1808, and/or each of the components described therein, and/or the steps of flowcharts 300, 400, 500, 700, 800, 1300, 1500, 1700, 1900, and/or 2000 are each implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

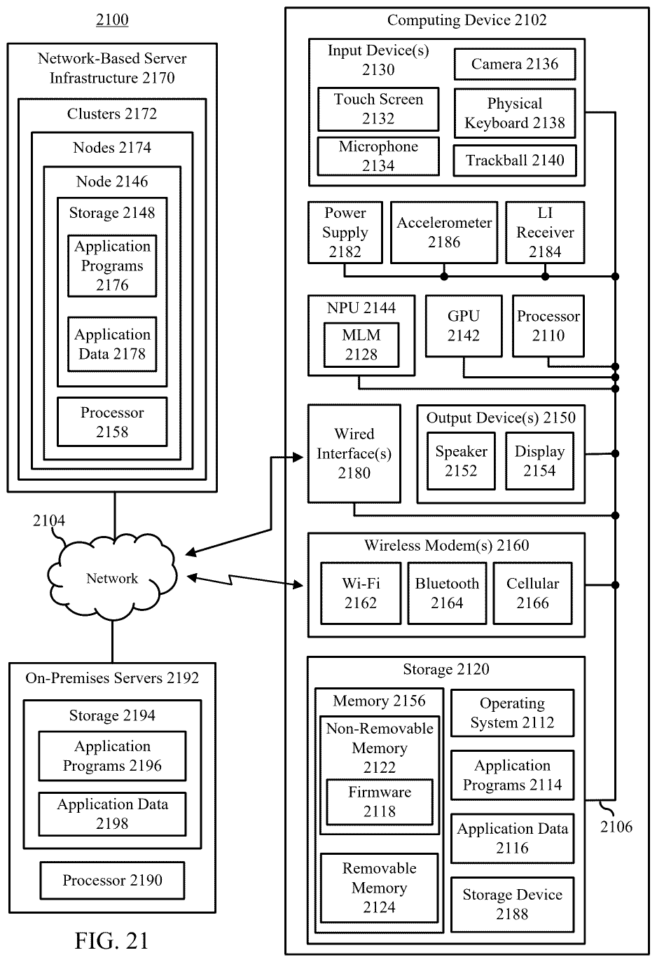

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 21. FIG. 21 shows a block diagram of an exemplary computing environment 2100 that includes a computing device 2102. Computing device 2102 is an example of computing device 102, learning plan generation system 104, assessment system 106, plan management system 108, content management system 110, credential management system 112, model server 114, API server 118, and/or model training system 1802, which each include one or more of the components of computing device 2102. In some embodiments, computing device 2102 is communicatively coupled with devices (not shown in FIG. 21) external to computing environment 2100 via network 2104. In accordance with an embodiment, network 2104 is an example of network 160 of FIG. 1. Network 2104 comprises one or more networks such as local area networks (LANs), wide area networks (WANs), enterprise networks, the Internet, etc. In examples, network 2104 includes one or more wired and/or wireless portions. In some examples, network 2104 additionally or alternatively includes a cellular network for cellular communications. Computing device 2102 is described in detail as follows.

Computing device 2102 can be any of a variety of types of computing devices. Examples of computing device 2102 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 2102 is a stationary computing device such as a desktop computer, a personal computer (PC), a stationary server device, a minicomputer, a mainframe, a supercomputer, etc.

As shown in FIG. 21, computing device 2102 includes a variety of hardware and software components, including a processor 2110, a storage 2120, a graphics processing unit (GPU) 2142, a neural processing unit (NPU) 2144, one or more input devices 2130, one or more output devices 2150, one or more wireless modems 2160, one or more wired interfaces 2180, a power supply 2182, a location information (LI) receiver 2184, and an accelerometer 2186. Storage 2120 includes memory 2156, which includes non-removable memory 2122 and removable memory 2124, and a storage device 2188. Storage 2120 also stores an operating system 2112, application programs 2114, and application data 2116. Wireless modem(s) 2160 include a Wi-Fi modem 2162, a Bluetooth modem 2164, and a cellular modem 2166. Output device(s) 2150 includes a speaker 2152 and a display 2154. Input device(s) 2130 includes a touch screen 2132, a microphone 2134, a camera 2136, a physical keyboard 2138, and a trackball 2140. Not all components of computing device 2102 shown in FIG. 21 are present in all embodiments, additional components not shown may be present, and in a particular embodiment any combination of the components are present. In examples, components of computing device 2102 are mounted to a circuit card (e.g., a motherboard) of computing device 2102, integrated in a housing of computing device 2102, or otherwise included in computing device 2102. The components of computing device 2102 are described as follows.

In embodiments, a single processor 2110 (e.g., central processing unit (CPU), microcontroller, a microprocessor, signal processor, ASIC (application specific integrated circuit), and/or other physical hardware processor circuit) or multiple processors 2110 are present in computing device 2102 for performing such tasks as program execution, signal coding, data processing, input/output processing, power control, and/or other functions. In examples, processor 2110 is a single-core or multi-core processor, and each processor core is single-threaded or multithreaded (to provide multiple threads of execution concurrently). Processor 2110 is configured to execute program code stored in a computer readable medium, such as program code of operating system 2112 and application programs 2114 stored in storage 2120. The program code is structured to cause processor 2110 to perform operations, including the processes/methods disclosed herein. Operating system 2112 controls the allocation and usage of the components of computing device 2102 and provides support for one or more application programs 2114 (also referred to as “applications” or “apps”). In examples, application programs 2114 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 2110 includes one or more general processors (e.g., CPUs) configured with or coupled to one or more hardware accelerators, such as one or more NPUs 2144 and/or one or more GPUs 2142.

Any component in computing device 2102 can communicate with any other component according to function, although not all connections are shown for ease of illustration. For instance, as shown in FIG. 21, bus 2106 is a multiple signal line communication medium (e.g., conductive traces in silicon, metal traces along a motherboard, wires, etc.) present to communicatively couple processor 2110 to various other components of computing device 2102, although in other embodiments, an alternative bus, further buses, and/or one or more individual signal lines is/are present to communicatively couple components. Bus 2106 represents one or more of any of several types of bus structures, including a memory bus or memory controller, a peripheral bus, an accelerated graphics port, and a processor or local bus using any of a variety of bus architectures.

Storage 2120 is physical storage that includes one or both of memory 2156 and storage device 2188, which store operating system 2112, application programs 2114, and application data 2116 according to any distribution. In an embodiment, storage 2120 is an example of storage 122 and/or storage 124 of FIG. 1. Non-removable memory 2122 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 2122 includes main memory and is separate from or fabricated in a same integrated circuit as processor 2110. As shown in FIG. 21, non-removable memory 2122 stores firmware 2118 that is present to provide low-level control of hardware. Examples of firmware 2118 include BIOS (Basic Input/Output System, such as on personal computers) and boot firmware (e.g., on smart phones). In examples, removable memory 2124 is inserted into a receptacle of or is otherwise coupled to computing device 2102 and can be removed by a user from computing device 2102. Removable memory 2124 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 2188 are present that are internal and/or external to a housing of computing device 2102 and are or are not removable. Examples of storage device 2188 include a hard disk drive, an SSD, a thumb drive (e.g., a USB (Universal Serial Bus) flash drive), or other physical storage device.

One or more programs are stored in storage 2120. Such programs include operating system 2112, one or more application programs 2114, and other program modules and program data. Examples of such application programs include computer program logic (e.g., computer program code/instructions) for implementing plan evaluator 120, client evaluator 122, learning plan generator 124, module executor 126, progress evaluator 128, credential assessor 130, plan generator 132, generative AI model 146, application 156, API gateway 158, credential validator 602, resource 604, skill object model 900, skill object model 1100, skill object model 1100, event detector 1202, solution executor 1602, training plan generator 1804, training plan executor 1806, model validator 1808, generative AI model 1810, and/or each of the components described therein, and/or the steps of flowcharts 300, 400, 500, 700, 800, 1300, 1500, 1700, 1900, and/or 2000, and/or any individual steps thereof.

Storage 2120 also stores data used and/or generated by operating system 2112 and application programs 2114 as application data 2116. Examples of application data 2116 include web pages, text, images, tables, sound files, video data, and other data. In examples, application data 2116 is sent to and/or received from one or more network servers or other devices via one or more wired or wireless networks. Storage 2120 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 2102 through one or more input devices 2130 and receives information from computing device 2102 through one or more output devices 2150. Input device(s) 2130 includes one or more of touch screen 2132, microphone 2134, camera 2136, physical keyboard 2138 and/or trackball 2140 and output device(s) 2150 includes one or more of speaker 2152 and display 2154. Each of input device(s) 2130 and output device(s) 2150 are integral to computing device 2102 (e.g., built into a housing of computing device 2102) or are external to computing device 2102 (e.g., communicatively coupled wired or wirelessly to computing device 2102 via wired interface(s) 2180 and/or wireless modem(s) 2160). Further input devices 2130 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 2154 displays information, as well as operating as touch screen 2132 by receiving user commands and/or other information (e.g., by touch, finger gestures, virtual keyboard, etc.) as a user interface. Any number of each type of input device(s) 2130 and output device(s) 2150 are present, including multiple microphones 2134, multiple cameras 2136, multiple speakers 2152, and/or multiple displays 2154.

In embodiments where GPU 2142 is present, GPU 2142 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 2142 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 2144 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 2128. In an example, NPU 2144 is configured for a data-driven parallel computing and is highly efficient at processing massive multimedia data such as videos and images and processing data for neural networks. NPU 2144 is configured for efficient handling of AI-related tasks, such as speech recognition, background blurring in video calls, photo or video editing processes like object detection, etc.

In embodiments disclosed herein that implement ML models, NPU 2144 can be utilized to execute such ML models, of which MLM 2128 is an example. In an embodiment, MLM 2128 is an example of generative AI model 146 of FIG. 1 and/or generative AI model 1810 of FIG. 18. For instance, where applicable, MLM 2128 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 2144 is used to train MLM 2128. To train MLM 2128, training data that includes input features (attributes) and their corresponding output labels/target values (e.g., for supervised learning) is collected. A training algorithm is a computational procedure that is used so that MLM 2128 learns from the training data. Parameters/weights are internal settings of MLM 2128 that are adjusted during training by the training algorithm to reduce a difference between predictions by MLM 2128 and actual outcomes (e.g., output labels). In some examples, MLM 2128 is set with initial values for the parameters/weights. A loss function measures a dissimilarity between predictions by MLM 2128 and the target values, and the parameters/weights of MLM 2128 are adjusted to minimize the loss function. The parameters/weights are iteratively adjusted by an optimization technique, such as gradient descent. In this manner, MLM 2128 is generated through training by NPU 2144 to be used to generate inferences based on received input feature sets for particular applications. MLM 2128 is generated as a computer program or other type of algorithm configured to generate an output (e.g., a classification, a prediction/inference) based on received input features, and is stored in the form of a file or other data structure.

In examples, such training of MLM 2128 by NPU 2144 is supervised or unsupervised. According to supervised learning, input objects (e.g., a vector of predictor variables) and a desired output value (e.g., a human-labeled supervisory signal) train MLM 2128. The training data is processed, building a function that maps new data on expected output values. Example algorithms usable by NPU 2144 to perform supervised training of MLM 2128 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 2128 is an LLM, MLM 2128 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 2128 is trained to learn patterns from unlabeled data. For instance, in embodiments where MLM 2128 implements unsupervised learning techniques, MLM 2128 identifies one or more classifications or clusters to which an input belongs. During a training phase of MLM 2128 according to unsupervised learning, MLM 2128 tries to mimic the provided training data and uses the error in its mimicked output to correct itself (i.e., correct weights and biases). In further examples, NPU 2144 perform unsupervised training of MLM 2128 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 2144 need not necessarily be present in all ML model embodiments. In embodiments where ML models are present, any one or more of processor 2110, GPU 2142, and/or NPU 2144 can be present to train and/or execute MLM 2128.

One or more wireless modems 2160 can be coupled to antenna(s) (not shown) of computing device 2102 and can support two-way communications between processor 2110 and devices external to computing device 2102 through network 2104, as would be understood to persons skilled in the relevant art(s). Wireless modem 2160 is shown generically and can include a cellular modem 2166 for communicating with one or more cellular networks, such as a GSM network for data and voice communications within a single cellular network, between cellular networks, or between the mobile device and a public switched telephone network (PSTN). In examples, wireless modem 2160 also or alternatively includes other radio-based modem types, such as a Bluetooth modem 2164 (also referred to as a “Bluetooth device”) and/or Wi-Fi modem 2162 (also referred to as an “wireless adaptor”). Wi-Fi modem 2162 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 2164 is configured to communicate with another Bluetooth-capable device according to the Bluetooth short-range wireless technology standard(s) such as IEEE 802.21.1 and/or managed by the Bluetooth Special Interest Group (SIG).

Computing device 2102 can further include power supply 2182, LI receiver 2184, accelerometer 2186, and/or one or more wired interfaces 2180. Example wired interfaces 2180 include a USB port, IEEE 1394 (FireWire) port, a RS-212 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 2180 of computing device 2102 provide for wired connections between computing device 2102 and network 2104, or between computing device 2102 and one or more devices/peripherals when such devices/peripherals are external to computing device 2102 (e.g., a pointing device, display 2154, speaker 2152, camera 2136, physical keyboard 2138, etc.). Power supply 2182 is configured to supply power to each of the components of computing device 2102 and receives power from a battery internal to computing device 2102, and/or from a power cord plugged into a power port of computing device 2102 (e.g., a USB port, an A/C power port). LI receiver 2184 is useable for location determination of computing device 2102 and in examples includes a satellite navigation receiver such as a Global Positioning System (GPS) receiver and/or includes other type of location determiner configured to determine location of computing device 2102 based on received information (e.g., using cell tower triangulation, etc.). Accelerometer 2186, when present, is configured to determine an orientation of computing device 2102.

Note that the illustrated components of computing device 2102 are not required or all-inclusive, and fewer or greater numbers of components can be present as would be recognized by one skilled in the art. In examples, computing device 2102 includes one or more of a gyroscope, barometer, proximity sensor, ambient light sensor, digital compass, etc. In an example, processor 2110 and memory 2156 are co-located in a same semiconductor device package, such as being included together in an integrated circuit chip, FPGA, or system-on-chip (SOC), optionally along with further components of computing device 2102.

In embodiments, computing device 2102 is configured to implement any of the above-described features of flowcharts herein. Computer program logic for performing any of the operations, steps, and/or functions described herein is stored in storage 2120 and executed by processor 2110.

In some embodiments, server infrastructure 2170 is present in computing environment 2100 and is communicatively coupled with computing device 2102 via network 2104. Server infrastructure 2170, when present, is a network-accessible server set (e.g., a cloud-based environment or platform). As shown in FIG. 21, server infrastructure 2170 includes clusters 2172. Each of clusters 2172 comprises a group of one or more compute nodes and/or a group of one or more storage nodes. For example, as shown in FIG. 21, cluster 2172 includes nodes 2174. Each of nodes 2174 are accessible via network 2104 (e.g., in a “cloud-based” embodiment) to build, deploy, and manage applications and services. In examples, any of nodes 2174 is a storage node that comprises a plurality of physical storage disks, SSDs, and/or other physical storage devices that are accessible via network 2104 and are configured to store data associated with the applications and services managed by nodes 2174.

Each of nodes 2174, as a compute node, comprises one or more server computers, server systems, and/or computing devices. For instance, a node 2174 in accordance with an embodiment includes one or more of the components of computing device 2102 disclosed herein. Each of nodes 2174 is configured to execute one or more software applications (or “applications”) and/or services and/or manage hardware resources (e.g., processors, memory, etc.), which are utilized by users (e.g., customers) of the network-accessible server set. In examples, as shown in FIG. 21, nodes 2174 includes a node 2146 that includes storage 2148 and/or one or more of a processor 2158 (e.g., similar to processor 2110, GPU 2142, and/or NPU 2144 of computing device 2102). Storage 2148 stores application programs 2176 and application data 2178. Processor(s) 2158 operate application programs 2176 which access and/or generate related application data 2178. In an implementation, nodes such as node 2146 of nodes 2174 operate or comprise one or more virtual machines, with each virtual machine emulating a system architecture (e.g., an operating system), in an isolated manner, upon which applications such as application programs 2176 are executed.

In embodiments, one or more of clusters 2172 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 2172 are included in a datacenter in a distributed collection of datacenters. In embodiments, exemplary computing environment 2100 comprises part of a cloud-based platform.

In an embodiment, computing device 2102 accesses application programs 2176 for execution in any manner, such as by a client application and/or a browser at computing device 2102.

In an example, for purposes of network (e.g., cloud) backup and data security, computing device 2102 additionally and/or alternatively synchronizes copies of application programs 2114 and/or application data 2116 to be stored at network-based server infrastructure 2170 as application programs 2176 and/or application data 2178. In examples, operating system 2112 and/or application programs 2114 include a file hosting service client configured to synchronize applications and/or data stored in storage 2120 at network-based server infrastructure 2170.

In some embodiments, on-premises servers 2192 are present in computing environment 2100 and are communicatively coupled with computing device 2102 via network 2104. On-premises servers 2192, when present, are hosted within an organization's infrastructure and, in many cases, physically onsite of a facility of that organization. On-premises servers 2192 are controlled, administered, and maintained by IT (Information Technology) personnel of the organization or an IT partner to the organization. Application data 2198 can be shared by on-premises servers 2192 between computing devices of the organization, including computing device 2102 (when part of an organization) through a local network of the organization, and/or through further networks accessible to the organization (including the Internet). Furthermore, in examples, on-premises servers 2192 serve applications such as application programs 2196 to the computing devices of the organization, including computing device 2102. Accordingly, in examples, on-premises servers 2192 include storage 2194 (which includes one or more physical storage devices such as storage disks and/or SSDs) for storage of application programs 2196 and application data 2198 and include a processor 2190 (e.g., similar to processor 2110, GPU 2142, and/or NPU 2144 of computing device 2102) for execution of application programs 2196. In some embodiments, multiple processors 2190 are present for execution of application programs 2196 and/or for other purposes. In further examples, computing device 2102 is configured to synchronize copies of application programs 2114 and/or application data 2116 for backup storage at on-premises servers 2192 as application programs 2196 and/or application data 2198.

Embodiments described herein may be implemented in one or more of computing device 2102, network-based server infrastructure 2170, and on-premises servers 2192. For example, in some embodiments, computing device 2102 is used to implement systems, clients, or devices, or components/subcomponents thereof, disclosed elsewhere herein. In other embodiments, a combination of computing device 2102, network-based server infrastructure 2170, and/or on-premises servers 2192 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 2120. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 2114) are stored in storage 2120. Such computer programs can also be received via wired interface(s) 2160 and/or wireless modem(s) 2160 over network 2104. Such computer programs, when executed or loaded by an application, enable computing device 2102 to implement features of embodiments discussed herein. Accordingly, such computer programs represent controllers of the computing device 2102.

Embodiments are also directed to computer program products comprising computer code or instructions stored on any computer-readable medium or computer-readable storage medium. Such computer program products include the physical storage of storage 2120 as well as further physical storage types.

### VIII. Additional Exemplary Embodiments

A method is described herein. The method comprises: receiving goal information corresponding to a target goal of a user account; determining, based on the goal information, the user account fails to satisfy a skill criterion of the target goal, the skill criterion specifying a first skill for satisfying the target goal; generating a first prompt that causes a generative artificial intelligence (AI) model to generate a learning plan associated with the first skill, the first prompt specifying the target goal and the first skill; providing the first prompt to the generative AI model; receiving the learning plan from the generative AI model, the learning plan comprising a first executable module for assessing if the user account satisfies first validation criterion corresponding to the first skill; and causing the first executable module to be executed.

In a further implementation of the foregoing method, the method further comprises: receiving an indication that the user account has completed the first executable module; validating a user response to the first executable module; and responsive to validation of the user response, assigning the first skill to the user account.

In a further implementation of the foregoing method, the first executable module comprises a question regarding a capability of a user to perform a task utilizing the first skill. The user response comprises a response to the question. Said validating the user response the program code is further comprises: determining the response to the question is correct.

In a further implementation of the foregoing method, the first prompt causes the generative AI model to: determine a first task the first skill is used to perform; and generate the first executable module to assess if the user account satisfies a first task criterion indicative that the user is able to perform the first task.

In a further implementation of the foregoing method, the first prompt causes the generative AI model to: determine a second task the first skill is used to perform; and generate a second executable module for assessing if the user account satisfies a second task criterion indicative that the user is able to perform the second task, wherein the learning plan further comprises the second executable module, and wherein the first validation criterion specifies an assessment that the first task criterion is satisfied and that the second task criterion is satisfied.

In a further implementation of the foregoing method, said determining the user account fails to satisfy the skill criterion of the target goal further comprises: identifying a first skill object model of the first skill, the first skill object model specifying an identifier of the first skill and a credential requirement of the first skill; and determining the user account fails to satisfy the credential requirement of the first skill.

In a further implementation of the foregoing method, the method further comprises: subsequent to execution of the first executable module, validating a user response to the first executable module; responsive to validation of the user response, assigning, to the user account, a verifiable credential corresponding to the first skill; determining, based at least on the user account being assigned the verifiable credential, the user account satisfies the credential requirement of the first skill; and determining, based on the determination of the user account satisfying the credential requirement, the user account satisfies the skill criterion of the target goal.

In a further implementation of the foregoing method, the method further comprises: receiving an access request to a resource on behalf of the user account, the access request comprising the verifiable credential; validating the verifiable credential; and enabling access to the resource responsive to validating the verifiable credential.

In a further implementation of the foregoing method, the target goal is a certificate and the method further comprises: determining the skill criterion based on certification criteria of the certificate.

In a further implementation of the foregoing method, the method further comprises: verifying, based at least on execution of the first executable module, the user account satisfies the first validation criterion; assign the first skill to the user account; responsive to a determination that the user account satisfies the certification criteria based at least on the first skill being assigned to the user account, transmit a certification request to a certification authority configured to assign the certificate to the user account.

In a further implementation of the foregoing method, the skill criterion specifies a second skill for satisfying the target goal; wherein the program code is further structured to cause the processor to determine the user account possesses the second skill; and said generating the first prompt comprises generating the first prompt specifying the target goal, the first skill, and an indication that the user account possesses the second skill.

Another method is described herein. The another method comprises: detecting a first development event with respect to a computer development program associated with a user account; determining, based on the first development event, a first potential solution to remedy the first development event; identifying a first skill criterion of the first potential solution, the first skill criterion corresponding to a first skill for performing the first potential solution; determining the user account fails to satisfy the first skill criterion; providing, to a generative artificial intelligence (AI) model, a first prompt that causes the generative AI model to generate a learning plan associated with the first skill, the first prompt specifying the first skill and the first potential solution; receiving the learning plan from the generative AI model, the learning plan comprising a first executable module for assessing if the user account satisfies validation criterion corresponding to the first skill; and causing the computer development program to execute the first executable module.

In a further implementation of the another foregoing method, said detecting the first development event comprises: executing a code evaluation module to detect the first development event based on development code in an interface of the computer development program.

In a further implementation of the another foregoing method, said detecting the first development event comprises: detecting user interaction with an interactive element presented in a user interface of the computer development program.

In a further implementation of the another foregoing method, the another method further comprises: detecting a second development event with respect to the computer development program; determining the user account satisfies a second skill criterion of a second skill based at least on the second development event; and assigning the second skill to the user account.

In a further implementation of the another foregoing method, the another method further comprises: detecting a second development event with respect to the computer development program; determining a plurality of potential solutions for remedying the second development event; receiving skill information specifying skills the user account possesses; selecting, based on the skill information, a second potential solution from among the plurality of potential solutions; and presenting the second potential solution in a user interface of the computer development program.

A method for training models is described herein. The model-training method comprises: receiving a set of training goals, the training goals specifying a model training target and a model architecture plan; determining a level of relevancy of a skill to the model training target based at least on the model architecture plan; responsive to determining the level of relevancy satisfies a relevancy criterion, utilizing a first generative artificial intelligence (AI) model to determine a training plan comprising instructions to train a second generative AI model on the skill; and utilizing the training plan to teach the second generative AI model on the skill.

In a further implementation of the foregoing model-training method, the method further comprises: causing the second generative AI model to utilize the skill to perform a model operation; and validating the second generative AI model based on a result of the model operation satisfying a validation criterion.

A system comprising a processor and memory is described herein. The memory storing program code is structured to cause the processor to perform any of the foregoing methods.

A computer-readable storage medium encoded with program instructions that, when executed by a processor circuit, perform any of the foregoing methods described herein.

### IX. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Further still, example embodiments have been described with respect skills such as performing tasks. These type of skills can also be referred to as “hard skills” or “technical skills.” In some embodiments, learning plans can be utilized for teaching or practicing “soft skills”. A soft skill is a psychosocial skill generally applicable to multiple goals, professions, or tasks. Examples of soft skills include, but are not limited to, leadership, digital literacy, work ethic, critical thinking, problem solving, public speaking, professional writing, and/or other psychosocial skills. In an embodiment, learning plan generation systems described herein generate learning plans for a user to practice, enhance, or learn soft skills. In an embodiment, assessment systems described herein assess performance of a user on a scale indicative of a degree of fluency the user has in the soft skill. In an embodiment, an assessment system utilizes a personality tests, behavioral surveys, objective psychological assessment, practice modules, and/or the like. In an embodiment, the assessment system aggregates multiple results for determining a level of competency a user possesses in a soft skill.

Moreover, according to the described embodiments and techniques, any components of systems, computing devices, servers, applications, learning plan generation systems, assessment systems, plan management systems, content management systems, credential management systems, model training systems, and/or their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A system comprising:
a processor; and
a memory that stores program code structured to cause the processor to:
receive goal information corresponding to a target goal of a user account,
determine, based on the goal information, the user account fails to satisfy a skill criterion of the target goal, the skill criterion specifying a first skill that satisfies the target goal,
generate a first prompt that causes a generative artificial intelligence (AI) model to generate a learning plan associated with the first skill, the first prompt specifying the target goal and the first skill,
provide the first prompt to the generative AI model,
receive the learning plan from the generative AI model, the learning plan comprising a first executable module corresponding to a first validation criterion corresponding to the first skill,
cause the first executable module to be executed,
automatically validate a completion of the first executable module based on the first validation criterion,
generate a verifiable token that indicates the user account satisfies the first validation criterion and attests the verifiable token is created by the system, and
transmit, to a computer-implemented credential management system, the verifiable token, causing the computer-implemented credential management system to assign the first skill to the user account.

2. The system of claim 1, wherein to determine the user account fails to satisfy the skill criterion of the target goal, the program code is further structured to cause the processor to:
identify a first skill object model of the first skill, the first skill object model specifying an identifier of the first skill, a relationship between the first skill and content, and a credential requirement of the first skill; and
determine the user account fails to satisfy the credential requirement of the first skill,
wherein the first prompt causes the generative AI model to identify the content based on the first skill object model and utilize the content to generate the first executable module.

3. The system of claim 2, wherein the program code is further structured to cause the processor to:
determine, based at least on the user account being assigned the verifiable token, the user account satisfies the credential requirement of the first skill; and
determine, based on the determination of the user account satisfying the credential requirement, the user account satisfies the skill criterion of the target goal.

4. The system of claim 3, wherein the program code is further structured to cause the processor to:
receive an access request to a resource on behalf of the user account, access to the resource requiring the first skill;
utilize the computer-implemented credential management system to validate assignment of the first skill to the user account based on the verifiable token; and
enable access to the resource responsive to validating the assignment of the first skill to the user account.

5. The system of claim 1, wherein the first prompt causes the generative AI model to:
determine a first task the first skill is used to perform; and
generate the first executable module, wherein the first validation criterion comprises to a first task criterion indicative that a user associated with the user account is able to perform the first task.

6. The system of claim 5, wherein the first prompt causes the generative AI model to:
determine a second task the first skill is used to perform; and
generate a second executable module corresponding to a second task criterion indicative that the user associated with the user account is able to perform the second task,
wherein the learning plan further comprises the second executable module, and
wherein the first validation criterion specifies an assessment that the first task criterion is satisfied and that the second task criterion is satisfied.

7. The system of claim 1, wherein, to automatically validate the completion of the first executable module, the program code is further structured to cause the processor to:
receive an indication that the user account has completed the first executable module; and
validate a user response to the first executable module based on the first validation criterion.

8. The system of claim 1, wherein the target goal is a certificate and the program code is further structured to cause the processor to:
determine the skill criterion based on certification criteria of the certificate.

9. The system of claim 8, wherein the program code is further structured to cause the processor to:
responsive to a determination that the user account satisfies the certification criteria based at least on the first skill being assigned to the user account, transmit a certification request to a certification authority configured to assign the certificate to the user account.

10. The system of claim 8, wherein the skill criterion specifies a second skill that satisfies the target goal;
wherein the program code is further structured to cause the processor to determine the user account possesses the second skill; and
to generate the first prompt, the program code is further structured to cause the processor to:
generate the first prompt specifying the target goal, the first skill, and an indication that the user account possesses the second skill.

11. A method comprising:
receiving, by a computer-implemented assessment system from a client computing device, a response to a first module indicative of interaction with the first module in a user interface of the client computing device, the first module corresponding to a first validation criterion corresponding to a first skill for satisfying a target goal;
automatically validating, by the computer-implemented assessment system, the response based on the first validation criterion;
generating, by the computer-implemented assessment system, a verifiable token that indicates the user account satisfies the first validation criterion and attests the verifiable token is generated by the computer-implemented assessment system; and
transmitting, to a computer-implemented credential management system, the verifiable token, the transmission of the verifiable token causing the computer-implemented credential management system to assign the first skill to the user account.

12. The method of claim 11, further comprising:
determining, by a computer-implemented learning plan generation system, the user account fails to satisfy a skill criterion of the target goal, the skill criterion specifying the first skill, wherein said determining the user account fails to satisfy the skill criterion comprising:
identifying a first skill object model of the first skill, the first skill object model specifying an identifier of the first skill and a credential requirement of the first skill, and
determining the user account fails to satisfy the credential requirement of the first skill.

13. (canceled)

14. The method of claim 11, wherein the method further comprises:
receiving an access request to a resource on behalf of the user account, the access request comprising the verifiable token;
validating the verifiable token; and
enabling access to the resource responsive to validating the verifiable token.

15. The method of claim 11, further comprising:
generating, by a computer-implemented learning plan generation system, a first prompt that causes a generative artificial intelligence (AI) model to generate a learning plan;
transmitting, by the computer-implemented learning plan generation system, the first prompt to the generative AI model, said transmitting the first prompt causing the generative AI model to:
determine a first task and a second task the first skill is used to perform,
generate the first module to assess if the user account satisfies a first task criterion indicative that a user associated with the user account is able to perform the first task, and
generate a second module corresponding to a second task criterion indicative that the user associated with the user account is able to perform the second task; and
generate the learning plan comprising the first module and the second module; and
causing, by the computer-implemented assessment system, at least the first module to be presented in the user interface of the client computing device,
wherein the first validation criterion specifies an assessment that the first task criterion is satisfied and that the second task criterion is satisfied.

16. The method of claim 11, wherein the target goal is a certificate and the method further comprises:
determining, by a computer-implemented learning plan generation system, a skill criterion of the target goal based on certification criteria of the certificate, the skill criterion specifying the first skill;
determining, by the computer-implemented assessment system, the user account satisfies the certification criteria based at least on the assignment of the first skill to the user account; and
transmitting a certification request to a certification authority configured to assign the certificate to the user account.

17. A computer-readable storage medium with program instructions encoded thereon, the program instructions structured to cause a processor to perform operations, the program instructions comprising:
a learning plan generator that, when executed by the processor:
receives goal information corresponding to a target goal of a user account,
determines, based on the goal information, the user account fails to satisfy a skill criterion of the target goal, the skill criterion specifying a first skill that satisfies the target goal,
generates a first prompt that causes a generative artificial intelligence (AI) model to generate a learning plan associated with the first skill, the first prompt specifying the target goal and the first skill,
provides the first prompt to the generative AI model, and
receives the learning plan from the generative AI model, the learning plan comprising a first executable module corresponding to a first validation criterion corresponding to the first skill; and
an assessor that, when executed by the processor:
causes the first executable module to be executed,
automatically validates a completion of the first executable module based on the first validation criterion,
generates a verifiable token that indicates the user account satisfies the first validation criterion and attests the verifiable token is created by the assessor, and
transmits, to a computer-implemented credential management system, the verifiable token, causing the computer-implemented credential management system to assign the first skill to the user account.

18. The computer-readable storage medium of claim 17, wherein to determine the user account fails to satisfy the skill criterion of the target goal, the learning plan generator:
identifies a first skill object model of the first skill, the first skill object model specifying an identifier of the first skill and a credential requirement of the first skill; and
determines the user account fails to satisfy the credential requirement of the first skill.

19. The computer-readable storage medium of claim 17, wherein, to automatically validate the completion of the first executable module, the assessment component further:
receives an indication that the user account has completed the first executable module; and
validates a user response to the first executable module.

20. The computer-readable storage medium of claim 19, wherein the program instructions further comprises a credential validator that:
receives an access request to a resource on behalf of the user account, the access request comprising the verifiable token;
validates the verifiable token; and
enables access to the resource responsive to validating the verifiable token.

21. The computer-readable storage medium of claim 20, wherein the credential validator validates the verifiable token based on the assignment of the first skill to the user account.
